(19) United States
(12) Patent Application Publication
(10) Pub. No.: US 2011/0298301 A1
(43) Pub. Date: Dec. 8, 2011

(54) APPARATUS, SYSTEM, AND METHOD HAVING A WI-FI COMPATIBLE ALTERNATING CURRENT (AC) POWER CIRCUIT MODULE

(75) Inventors: Simon Wong, Los Altos, CA (US); J. Marcus Stewart, San Jose, CA (US); Richard Mincher, Cupertino, CA (US); John Metzger, Campbell, CA (US); Dale Loia, San Jose, CA (US); Eric Wai, Los Altos Hills, CA (US); Jacob Chang, Cupertino, CA (US)

(73) Assignee: Equal Networks, Inc., Mt. View, CA (US)

(21) Appl. No.: 13/090,134

(22) Filed: Apr. 19, 2011

Related U.S. Application Data
(60) Provisional application No. 61/326,188, filed on Apr. 20, 2010.
(60) Provisional application No. 61/326,189, filed on Apr. 20, 2010.
(60) Provisional application No. 61/326,191, filed on Apr. 20, 2010.
(60) Provisional application No. 61/326,195, filed on Apr. 20, 2010.
(60) Provisional application No. 61/326,197, filed on Apr. 20, 2010.

(51) Int. Cl. H01H 35/00; G06F 19/00

(52) U.S. Cl. 307/116; 702/62

(57) ABSTRACT

An apparatus, system, and method includes a housing having at least one inlet plug suitable for connection to an alternating current (AC) power outlet and at least one outlet receptacle suitable receiving an AC plug connected to a load device. An AC measurement module is contained within the housing and is coupled to the inlet plug and the outlet receptacle to measure AC voltage and AC current usage of the load device connected to the outlet receptacle. A communication module is operative to transmit AC power values calculated based on the measured AC voltage and AC current in accordance with the IEEE 802.11 wireless networking standard (Wi-Fi) to a wireless network access point.

### CROSS REFERENCE TO RELATED APPLICATIONS

This application claims the benefit under 35 USC §119(e) of U.S. Provisional Patent Application Ser. No. 61/326,188, filed Apr. 20, 2010 and entitled “Environmental Monitoring Using Specifically Purposed WiFi-Sensors In Datacenter Facilities”; U.S. Provisional Patent Application Ser. No. 61/326,189, filed Apr. 20, 2010 and entitled “A Method And Apparatus For Using WiFi-Compatible Wireless Sensor Specifically Purposed For Determining The Optimal Temperature Conditions Of A Datacenter Infrastructure To Save Electrical Energy”; U.S. Provisional Patent Application Ser. No. 61/326,191, filed Apr. 20, 2010 and entitled “A WiFi Compatible Wireless Sensor Specifically Purposed For Determining Critical AC Power Conditions On A Per Rack Basis Of A Datacenter”; U.S. Provisional Patent Application Ser. No. 61/326,195, filed Apr. 20, 2010 and entitled “A Wireless Sensor For Determining Critical Environmental Conditions On A Per Rack Basis For A Datacenter Infrastructure”; U.S. Provisional Patent Application Ser. No. 61/326,197, filed Apr. 20, 2010 and entitled “A WiFi Compatible AC power meter Module Specifically Purposed To Determine AC Power Conditions On Any Apparatus Using Electrical Alternating Current For Power”; each of which is hereby incorporated by reference in its entirety.

### BACKGROUND

The present disclosure relates to an apparatus, system, and method of utilizing a wireless network to communicate with one or more wireless sensors and/or actuators to monitor and obtain information about a datacenter. A datacenter is a facility used to house data storage and processing equipment that can perform a variety of data storage and computational tasks. Datacenter facilities may also host servers, web servers, Internet services, and other enterprise-based services, computer systems and associated components, such as telecommunications systems, among other equipment. The datacenter generally includes redundant or backup power supplies, redundant data communications connections, environmental controls (e.g., air conditioning, fire suppression) and security devices.

High carbon gas emissions are causing global warming concerns. Along with global warming, energy costs are skyrocketing, specifically, electrical energy use. There exists tremendous pressure on the information technology (IT) industry to cut back on their energy use and to monitor and track the how much alternating current (AC) power is used by equipment located in the datacenter. According to the environmental protection agency (EPA), datacenters across the United States (US) use 3% of all of the electricity used in the US. Therefore, there is a strong movement afoot to reduce the energy consumption of datacenters across the country and to become as efficiently green as possible because green is good for the planet.

There exists in a typical datacenter, constant AC power use in the equipment. Every equipment rack may contain one or more IT server which is critical to running modern businesses. Each rack's total AC power usage is very difficult to monitor. Datacenter managers are currently blind to this AC power usage and have no visibility as to the amount of AC power being used on a per rack basis or during periods when AC power usage is highest. Industry organizations such as Uptime Institute, Green Grid, American Society of Heating, Refrigerating and Air-Conditioning Engineers (ASHRAE), and Network Equipment-Building System (NEBS) have all recommended that datacenters measure the AC power usage and compare that usage value to the industry and to use the total AC power usage as compared to the overall building AC power usage to determine an industry metric for efficiency. Accordingly, datacenter managers who wish to calculate the industry metric for efficiency do not have the tools in place to instrument and monitor this AC power usage with disrupting other equipment in doing so. The ability to measure the AC power usage of the datacenter equipment provides a datacenter manager with full knowledge of the AC power consumed by each of the equipment loads and the variance of such consumption during different parts of the day.

Conventional techniques dictate that measuring the AC current consumption of datacenter equipment involves using an ammeter, either a clamp-on type or an in-line type, attached to the equipment under test. These ammeters are placed around a power cord or are wired connected to the equipment under test. These wired solutions are cumbersome to implement because wires or cables are drooped over the operating equipment causing a jumbled mess. As a result, managers are reluctant to implement such wired current metering solutions, and if so, only temporarily. In addition, a serviceperson or technician would be required to physically near to view the current readings of the ammeter periodically, as they are sometimes not machine readable or remotely readable. There exists machine readable devices, but they too require cable for transmitting the readings, which means this “data” cable can be a cause of the jumbled mess. To perform this task is time consuming and requires that the serviceperson manually take the ammeter readings and log the results. Such manual intervention is error-prone and inaccurate because it introduces errors in the process of reading the meters and converting the reading to a machine readable form. There has been some innovation to electronically measure and record the amount of current consumed by equipment in the datacenter but no innovation to provide the recorded readings wirelessly to an Internet dashboard application for display.

In addition, most datacenter facilities are inefficient because they waste energy by over cooling. Accordingly, there is tremendous inefficiency and waste in supplying more cooling than is required to properly cool the equipment. Wasted cooling is wasted energy use. Industry leaders such as IBM, Hewlett-Packard, Uptime Institute, Green Grid, ASHRAE, and NEBS have recommended datacenter facilities to operate at a server inlet temperature (set-point) of 27° C. or 80.6° F. Conventional datacenter technology adjusts the set-point based on the room thermostat measurements, located on walls, and is not based on actual measurements made at the equipment rack, which manufacturers prefer. A large percentage of the datacenter facility energy costs arise from the environmental controls required to ensure that the environment within the data facility is maintained within suitable parameters based on the equipment contained in the facility. Examples of environmental controls include cooling, air flow, humidity controls, power regulators, and so on. All of these controls work together to attempt to create an environment in which the data facility equipment can operate at maximum efficiency and thus decrease the overall energy costs for the data facility. Datacenter managers, however, are unwilling to blindly raise their set-points without having a second, more granular data point of confirmation. They need confidence that by changing room set-points or by adjusting their equipment in any manner, they will not jeopardize the “thermal health” safety of the equipment on the racks.

Today's datacenter environment is changing constantly. Workload problems can arise in a datacenter facility when the equipment servers' environmental conditions fail to remain within acceptable operating parameters. Hot spots can cause equipment to run at less than optimal efficiency and at extremes can result in equipment failure and service interruptions. Excess humidity can allow condensation to form in and around data facility equipment and result in data processing and storage errors and ultimately, equipment failure. To control environmental conditions such as temperature and humidity, a data facility administrator needs to be aware of both global and local environmental conditions within the facility.

To enable data facility designers and administrators to determine optimal placement and settings for environmental controls, some form of environmental monitoring is desirable. Most current forms of environmental monitoring are difficult to implement and tend to create an incomplete and inaccurate image of data facility environmental conditions. Current temperature monitoring systems do not demand that sensors be placed on every rack in the datacenter, instead, a sensor may be placed on every other rack or every third rack, implying this correctly represents the inlet temperatures of all the racks in between. This patent claims that every rack in the datacenter must be instrumented with a sensor or multiple sensors to indicate the rack inlet temperatures experienced by that rack of equipment. Any deviation from this gives an incomplete picture and allows the consequence of a mistake in measurement and instills an area of non-confidence with the datacenter staff personnel.

Understanding heat profiles at each rack and the “hot spots” in a datacenter is very difficult and the lack of knowledge prevents managers from making any changes. The risks of randomly making changes are high and may adversely affect expensive equipment, without having confident, real-time temperature measurements about them at the point of interest such as the air inlet. Datacenter managers have no practical and inexpensive method to measure the temperature at every single rack today. Current technology is too expensive, inlet temperatures reported by servers are difficult to act upon, servers internal reported temperatures of inlet temperatures are inappropriate to guide the datacenter, and some wired solutions make it difficult to operate the server equipment, due to cable draping. Managers need visibility and confidence that by changing room set-points or by adjusting their equipment in any manner, they are not jeopardizing the “thermal health” and safety of the equipment in the racks.

Current technology requires a wired solution with cabled probes which are installed inside the equipment rack. The wired probes are extended to locate the probe temperature at exactly where an inlet temperature is needed. This cable solution drapes cabling and wiring, sometimes over operating equipment, causing a difficult access condition, and perhaps introduces an equipment downtime condition. Some wired sensors are instrumented inside equipment racks and some wired sensors are instrumented in the datacenter room. The combination of readings from these wired sensors determined the overall thermal profile of the datacenter. Due to the high cost of installation, monitoring, and maintenance of these wired temperature sensors, the total cost for outfitting the datacenter with instruments is expensive and complex to implement. As a result of the high cost, not every rack is instrumented, which leaves the datacenter manager guessing or estimating the rack temperatures of the non-instrumented racks. Due to the nature of blade servers, the concentration of heat is focused into a tighter area than previous, and the temperatures differ between upper and lower parts of the equipment racks. There will always exist some doubt about the performance of the un-instrumented racks, when you don't instrument all racks.

A less than full instrumentation of every rack with sensor detectors is insufficient to properly profile a datacenter and is in fact, very risky to take actions without a full comprehensive indication. Today, we understand that the Rack Air Inlet temperature (RAI) is the most important parameter for properly functioning IT equipment, and is the lone specification server manufacturers require for their equipment. Every equipment rack's front air inlet temperature should be tracked to be within the temperature ranges specified by the equipment manufacturer.

Conventional techniques dictate that either wired sensors or sensors based on IEEE 802.15.4 be instrumented in a datacenter to determine the temperature of certain regions of the datacenter. Prior solutions involve certain environmental detection, which included temperature and humidity, in either a wired sensor solution or wireless sensors operating under IEEE 802.15.4 PHY layers. This goes by ZigBee/802.15.4/mesh networks. This class of wireless has technical limits of bandwidth and reliability transmissions. The ZigBee technology is aggregated at 250 Kbps transmission, which is insufficient to support a large number of sensors (>1000), or large bandwidth media requirements. Audio and video media typically need 1 Mbps bandwidth for MPEG-2 quality. For a facility manager, who wants one wireless infrastructure that supports from environmental measurements through to video surveillance, ZigBee is not able to support this, due to the bandwidth required. In the case of Zigbee, the facility manager must implement two wireless infrastructures, one for environment and another different wireless technology for audio and video applications. These sensors were limited in their ability to properly monitor today's critical datacenters.

Today's datacenter requires that sensors be a sophisticated computer equipment with the ability to incorporate a number of sensing devices specifically tailored to the usage in a datacenter that has never existed before in these combinations and to use common wireless IEEE 802.11b/g networks, commonly referred to as Wi-Fi networks, for their communications. Wi-Fi has emerged as the worldwide standard for wireless Internet access in the enterprise. The IEEE 802.11 (Wi-Fi) standard eliminates the expense and complexity of RFID-based or proprietary systems, enabling a supply chain solution that leverages existing technologies, tools, and infrastructure. Wi-Fi is already installed in warehouses, distribution centers, loading docks, delivery trucks and even airport tarmacs. The 2.4 GHz Wi-Fi frequency band has been approved around the world, and proven to be much more robust than competing wireless technologies, such as ZigBee/802.15.4. The Wi-Fi standard provides easy access, high performance and reliable security.

### SUMMARY

In accordance with one embodiment, an apparatus, system, and method comprises a housing comprising at least one inlet plug suitable for connection to an alternating current (AC) power outlet and at least one outlet receptacle suitable receiving an AC plug connected to a load device. An AC measurement module is coupled to the inlet plug and the outlet receptacle to measure AC voltage and AC current usage of the load device connected to the outlet receptacle. A communication module operative to transmit AC power values calculated based on the measured AC voltage and AC current in accordance with the IEEE 802.11 wireless networking standard (Wi-Fi) to a wireless network access point.

### BRIEF DESCRIPTION OF THE FIGURES

The novel features of the various aspects of the present invention are set forth with particularity in the appended claims. The various aspects, however, both as to organization and methods of operation, are described herein by way of example in conjunction with the following figures and corresponding description, where like reference numbers refer to like elements throughout.

FIG. 1 illustrates one embodiment of a system for monitoring a datacenter.

FIG. 2 illustrates one embodiment of a system for monitoring a datacenter.

FIG. 3 illustrates one embodiment of a system for monitoring a datacenter.

FIG. 4 illustrates one embodiment of a system for monitoring a datacenter.

FIG. 5 illustrates one embodiment of a system for monitoring a subscriber premise (e.g., a datacenter).

FIG. 6 illustrates one embodiment of a video capture Wi-Fi sensor module.

FIG. 7A illustrates one embodiment of a single in-line AC power meter Wi-Fi sensor module.

FIG. 7B illustrates one embodiment of an AC power meter Wi-Fi sensor module in the form of a power strip with multiple outlets to enable multiple devices to be plugged in.

FIG. 7C illustrates one embodiment of an AC power meter Wi-Fi sensor module embedded in a power strip with multiple outlets to enable multiple devices to be plugged in.

FIG. 7D illustrates one embodiment of an AC power meter Wi-Fi sensor module embedded in a power block.

FIG. 8 illustrates one embodiment of a Wi-Fi sensor module for monitoring environmental conditions.

FIG. 9 illustrates a functional block diagram of a video capture Wi-Fi sensor module shown in FIG. 6.

FIG. 10 is a functional block diagram of an AC power meter Wi-Fi sensor modules shown in FIGS. 7A and 7B.

FIG. 11 is a functional block diagram of an environmental Wi-Fi sensor module shown in FIG. 8.

FIG. 12 is a representative screen shot of an historical data window associated with a datacenter is displayed by a dashboard application.

FIG. 13 illustrates a screen shot of a Main window displayed by the dashboard application.

FIG. 14 illustrates a screen shot of a Minimum/Maximum/Average Chart window displayed by the dashboard application.

FIG. 15 is a screen shot of a Datacenter Window displayed by the dashboard application.

FIG. 16 is a screen shot of a Datacenter Heat Map window displayed by the dashboard application.

FIG. 17 is a screen shot of a Sensor window displayed by the dashboard application.

FIG. 18 is a screen shot of a Configuration Panel window displayed by the dashboard application.

FIG. 19 is a screen shot of a Sensor Move window displayed by the dashboard application.

FIG. 20 is a screen shot of a Profile window displayed by the dashboard application.

FIG. 21 is a screen shot of an Assessment Tool window displayed by the dashboard application.

FIG. 22 illustrates one embodiment of a system for monitoring the AC power load among other quantities of a server located at a subscriber premise (e.g., a datacenter).

FIG. 23 illustrates one embodiment of a computing device which can be used in one embodiment of a system to implement the various described embodiments for the computer implemented dashboard and the computer implemented control method, among others, as set forth in this specification.

### DESCRIPTION

In one embodiment, the present disclosure provides apparatuses, systems, and methods of utilizing a wireless network to communicate with one or more wireless sensors and/or actuators for monitoring and obtaining information about a datacenter. The information about the datacenter is measured by sensors and is wirelessly transmitted to a local wireless network connected to a wide area network such as the Internet. The measured data accumulated and is used to configure, modify settings, and administrate the datacenter manually and/or automatically in order to operate the datacenter more efficiently and to realize annual cost savings on energy usage.

The sensors are configured to measure one or more quantities such as: temperature, heat, electrical resistance, electrical current, electrical voltage, electrical power, magnetism, pressure gas and liquid flow, gas and liquid, odor, viscosity and density, humidity, chemical proportion, light time-of-flight, light, image, infra-red, proximity, radiation, subatomic particle, hydraulic, acoustic, sound, motion, vibration, orientation, distance, biological, geodetic. As described in more detail below, the sensors can be broadly divided into (1) “multimedia,” encompassing the measurement of still images, moving images (video), and sound; (2) “electrical metering,” encompassing electrical resistance, electrical current, electrical voltage, electrical power; and (3) “environmental,” encompassing all other categories of quantities to measured or sensed, such as temperature, heat, magnetism, pressure, gas and liquid flow, gas and liquid volume, odor, viscosity and density, humidity, chemical proportion, light, time-of-flight, infrared, proximity, radiation, subatomic particle, hydraulic, acoustic, motion, vibration, orientation, distance, biological, geodetic. The quantities to be measured are not exhaustive and are listed here for convenience and clarity of disclosure. Accordingly, it will be appreciated that there may be additional quantities of interest that may be measured in a datacenter using a suitably configured sensor as described hereinbelow within this specification. Reference herein to a sensor or wireless sensor is intended to mean a sensor or wireless configured for measuring one or more of the above listed quantities, without limitation.

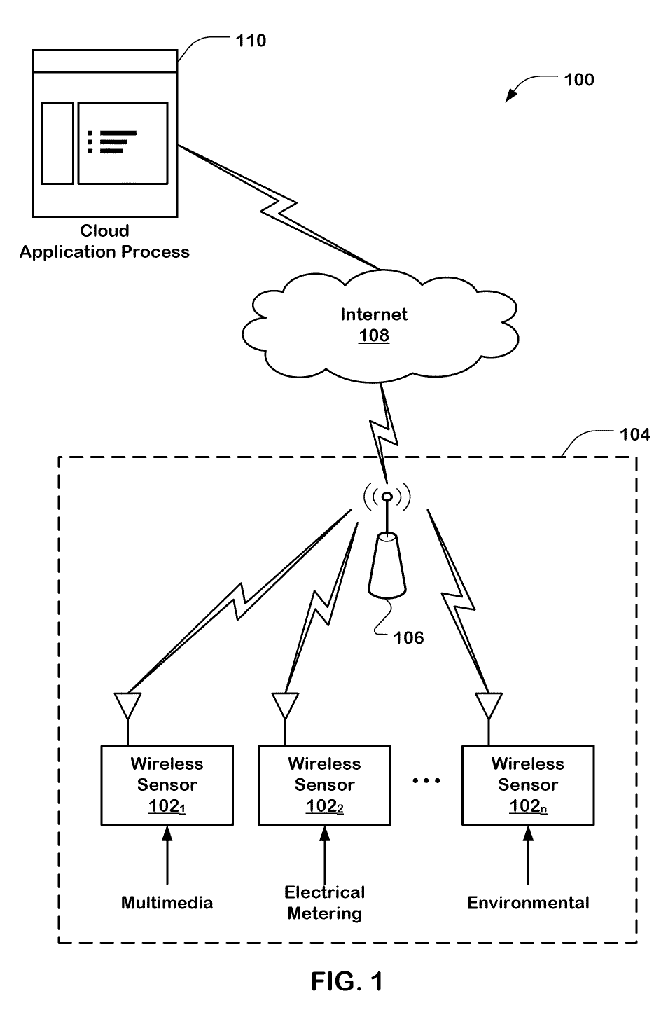

FIG. 1 illustrates one embodiment of a system 100 for monitoring a datacenter 104. In one embodiment, the system 100 comprises one or more wireless sensors, a bridge server, a network, a broadband Internet access, and an Internet application service. The wireless sensors act as the senses needed inside the datacenter 104 in order to properly monitor, report, and manage operating conditions within the datacenter 104.

In one embodiment, various conditions associated with the datacenter 104 are monitored by specifically purposed wireless sensors 102₁, 102₂, 102ₙ, where n is any positive nonzero integer. Each of the wireless sensors 102₁₋ₙ comprises a processor system, a memory, a radio frequency communications system, and a battery power system. The wireless sensors 102₁₋ₙ may be arranged in a network configuration capable of wireless communication with a wireless network access point 106 using the IEEE 802.11b/g radio frequency (RF) infrastructure Wi-Fi radio frequency and protocol. Hence, in one aspect, the wireless sensors 102₁₋ₙ may be referred to herein as a network of Wi-Fi sensor modules 102₁₋ₙ or simply Wi-Fi sensor modules. In one embodiment, the Wi-Fi sensor modules 102₁₋ₙ are enclosed in a package, operate only under battery power, communicate over an existing Wi-Fi infrastructure, and are completely wireless for purposes of monitoring physical, electrical, and environmental conditions of the datacenter 104 or equipment located within the datacenter 104. In one aspect, physical, electrical, and environmental conditions of the datacenter 104 may be monitored using the Wi-Fi sensor modules 102₁₋ₙ and the monitored quantities may be communicated over the Wi-Fi infrastructure in order to control the operation of the datacenter 104 and make it more energy efficient.

In one embodiment, the network of wireless Wi-Fi sensor modules 102₁₋ₙ is arranged in the datacenter 104 to monitor a variety of conditions associated with the datacenter 104. Each of the sensors 102₁₋ₙ are preprogrammed to automatically generate data describing the specific conditions which it is specifically configured to sense. For example, as shown in FIG. 1, a multimedia wireless sensor 102₁ may be configured for monitoring audio and visual information such as, without limitation, still images, moving images (video), or sound within the datacenter 104. An electrical metering wireless sensor 102₂ may be configured for monitoring, without limitation, electrical resistance, electrical current, electrical voltage, electrical power such as AC power consumption at the datacenter 104. Environmental wireless sensor 102ₙ may be configured for monitoring environmental conditions at the datacenter 104 such as, without limitation, temperature, heat, magnetism, pressure, gas and liquid flow, gas and liquid volume, odor, viscosity and density, humidity, chemical proportion, light, time-of-flight, infrared, proximity, radiation, subatomic particle, hydraulic, acoustic, motion, vibration, orientation, distance, biological, or geodetic. Additional suitable configured wireless sensors may be included in the wireless sensor network to monitor any desired condition associated with the datacenter 104.

The Wi-Fi sensor modules 102₁₋ₙ generally do not rely on any cables, wires, or other harnesses for supplying data or power transmissions. There are no exterior connections to the Wi-Fi sensor modules 102₁₋ₙ devices other than through wireless communications to the wireless access point 106. In one embodiment, the Wi-Fi sensor modules 102₁₋ₙ disclosed herein are specifically configured to operate in accordance with the IEEE 802.11 standard. The Wi-Fi sensor modules 102₁₋ₙ are powered by battery so that there are no wired, cabled, or harnessed connections supplying power to the device.

In various embodiments, each of the Wi-Fi sensor modules 102₁₋ₙ may be configured to monitor various environmental conditions and physical conditions associated with the datacenter 104. Each of these senses are wirelessly transmitted to a repository server which can then process the environmental and physical data sent, to produce an environmental depiction of at least part of the datacenter 104; and making the environmental depiction available for viewing on Internet enabled dashboards depicted in FIG. 1 as the cloud application process 110. In particular, the data sensed by the Wi-Fi sensor modules 102₁₋ₙ are transmitted over Wi-Fi RF to the wireless access point 106 to access a wide area network 108 such as the Internet. The Wi-Fi sensor module 102₁₋ₙ information is transmitted to one or more remote servers to be processed by a cloud application process 110 also referred to herein as a computer implemented method such as a dashboard application, control application, or combinations thereof.

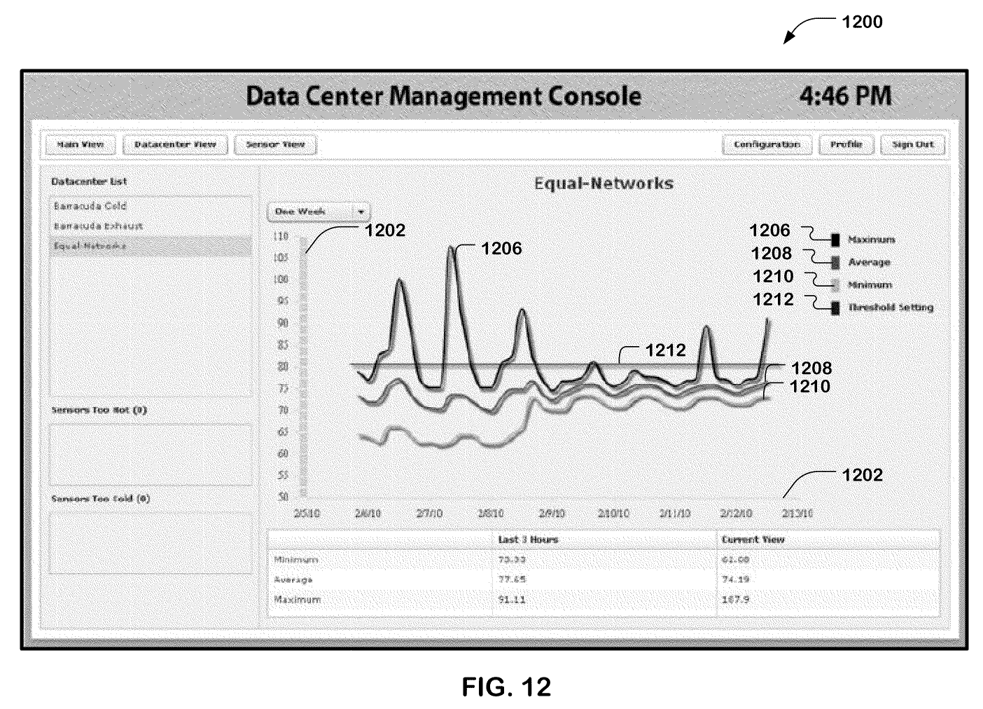

The cloud application process 110 accumulates the Wi-Fi sensor modules 102₁₋ₙ data, manages the data, and using the data generates an environmental description of all or a portion of the datacenter 104 facility, a visual representation of the conditions at the datacenter 104, and/or generates signals to control the operation of the datacenter 104. The environmental description is viewed by the datacenter 104 facility personnel and can be used to manipulate one or more environmental conditions of the datacenter 104 facility. In various embodiments, specific types of senses are used to monitor the datacenter 104. The monitored information is transmitted to the cloud application process 110 over the Internet network 108 via the access point 106. In one aspect, the cloud application process 110 is a computer implemented software application program executing on a remote server, which receives the information associated with the datacenter 104 as recorded and transmitted by the Wi-Fi sensor modules 102₁₋ₙ. The cloud application process 110 also provides the information associated with the datacenter 104 on a dashboard like display, as described in more detail hereinbelow in connection with FIGS. 12-21.

In one aspect, for example, at least one of the Wi-Fi sensor modules 102₁₋ₙ may be configured to monitor the temperature at the air inlet of every server rack and the room ambient temperature, light level, humidity levels, of the datacenter 104. In other aspects, at least one of the Wi-Fi sensor modules 102₁₋ₙ may be configured to record video or picture in the datacenter 104 and transmit the video or picture to the cloud application process 110. Still in other aspects, at least one of the Wi-Fi sensor modules 102₁₋ₙ may be configured for metering the AC power consumed by the datacenter 104 or by the individual equipment in the datacenter 104. All the measurements are reported to the cloud application process 110 in order to adjust cooling solutions or heating solutions to maintain the desired temperature for the datacenter 104, watch over the security of the datacenter 104, or monitor the AC power consumption of the datacenter 104.

In aspects, for example, one or more of the Wi-Fi sensor modules 102₁₋ₙ may be configured to monitor odor emitted from certain equipment at the datacenter 104, which may indicate a burning condition at the datacenter 104. Upon notice that such odor was detected by the Wi-Fi sensor module 102₁₋ₙ, the datacenter 104 management may investigate the cause.

In another aspect, for example, one or more of the Wi-Fi sensor modules 102₁₋ₙ may be configured to monitor humidity. The humidity of the datacenter equipment and the room itself must be maintained properly so as not to create moist conditions in the datacenter 104. Excess moisture may cause condensation of the equipment and the resulting water drops leading to failed equipment.

In another aspect, for example, one or more of the Wi-Fi sensor modules 102₁₋ₙ may be configured to monitor light radiation. Light radiation detection provides a form of security inside the datacenter 104. Current datacenters 104 operate with the “lights out” in order to save power. These lights out conditions also mean that no personnel should be in the datacenter 104 during restricted time periods. If a light on condition is detected by one of the Wi-Fi sensor modules 102₁₋ₙ, then it means an unauthorized entry exists and an alert system should be initiated.

In another aspect, for example, one or more of the Wi-Fi sensor modules 102₁₋ₙ may be configured to monitor electric current usage. A measure of electrical current on every datacenter equipment or groups of equipment provides a way to understand the amount of power used by the IT load during various times of the day. This knowledge is used to optimize and prepare the datacenter 104 for excess loads, determine a green baseline, or for efficiency programs.

In another aspect, for example, one or more of the Wi-Fi sensor modules 102₁₋ₙ may be configured to monitor electric voltage. A measure of electrical voltage on single equipment or groups of equipment provides a way to understand the amount of power used by the IT load during various times of the day. This knowledge is used to optimize and prepare the datacenter 104 for excess loads, determine a green baseline, or for efficiency programs.

In another aspect, for example, one or more of the Wi-Fi sensor modules 102₁₋ₙ may be configured to monitor acoustics. Monitoring acoustics provides a way to detect when the datacenter equipment racks begins to sound or vibrate differently than previous. Such differences in acoustics suggest that some portion of the equipment may become faulty. One instance is the fans stops turning will produce a different vibration than when operating. Such information is useful to the manager of the datacenter 104 for early and proactive maintenance of the equipment.

In another aspect, for example, one or more of the Wi-Fi sensor modules 102₁₋ₙ may be configured to monitor sound. Monitoring sound provides a way to detect when the datacenter equipment begins to vibrate or vibrate differently than previous. Such differences in sound suggest that equipment may become faulty. One instance is the fans stops turning will produce a different vibration than when operating. Such information is useful to the manager of the datacenter 104 for early maintenance of the equipment.

In another aspect, for example, one or more of the Wi-Fi sensor modules 102₁₋ₙ may be configured to monitor vibration. Monitoring vibration provides a way to detect when the datacenter equipment begins to vibrate or vibrate differently than previous. Such differences or vibrations suggest that equipment may become faulty. One instance is the fans stops turning will produce a different vibration than when operating. Such information is useful to the manager of the datacenter 104 for early maintenance of the equipment.

In another aspect, for example, one or more of the Wi-Fi sensor modules 102₁₋ₙ may be configured to monitor orientation and location determination. The Wi-Fi sensor modules 102₁₋ₙ in the datacenter 104 may be configured to report back their orientation and location determination with respect to the floor of the datacenter 104. Such orientation and location awareness information reports how the sensors are attached to the datacenter equipment and the location of the equipment for asset tracking.

In another aspect, for example, one or more of the Wi-Fi sensor modules 102₁₋ₙ may be configured to monitor distance. Monitoring distance in a datacenter provides a way to estimate the location of the datacenter equipment. One such use is to locate and place three-dimensionally, the location of the Wi-Fi sensor modules 102₁₋ₙ. Knowing the location of the Wi-Fi sensor modules 102₁₋ₙ allows a self-discovery of the sensors and dimensionally accurate placing of the sensors on the dashboard of the cloud application process 110.

In another aspect, for example, one or more of the Wi-Fi sensor modules 102₁₋ₙ may be configured to monitor geodetic measurements. Monitoring geodetic measurements in the datacenter 104 provides a way to detect a potential earthquake situation. Upon such an early detection, managers of the datacenter 104 may provide early shut-down of the equipment and save damage or loss of data.

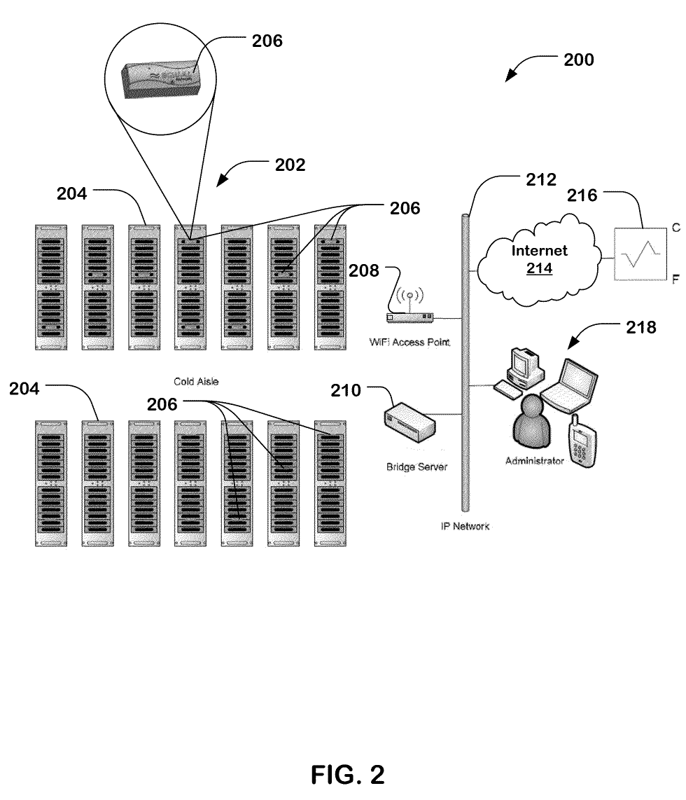

FIG. 2 illustrates one embodiment of a system 200 for monitoring a datacenter 202. In one embodiment, the system 200 comprises one or more specifically configured IEEE 802.11-based wireless sensors 206 (Wi-Fi sensor modules 206), a Wi-Fi access point 208, a Wi-Fi bridge server 210, a Wi-Fi enabled network 212, a broadband Internet access 214, and an Internet application 216 service. The network of Wi-Fi sensor modules 206 act as the senses needed inside the datacenter 202 in order to properly manage and report failed operating conditions therein. An administrator 218 can monitor the datacenter 202 using any server connected to the Internet 214.

In one embodiment, the Wi-Fi sensor modules 206 may be configured as wireless sensors and/or wireless actuators and utilize an existing Wi-Fi network to communicate information. The Wi-Fi sensor modules 206 can be configured to monitor a variety of parameters such as air inlet temperature, for example, on the one or more servers 204 on a per rack basis. The monitored accumulated information from the IEEE 802.11 wireless Wi-Fi sensor modules 206 and/or wireless actuators is employed to configure, modify settings, and administrate the datacenter 202 manually and/or automatically by the administrator 218 or any server connected to the Internet 214. The datacenter 202 cooling equipment can be controlled remotely to operate on a more efficient basis and to realize annual cost savings on the electrical power used by the cooling equipment.

The Wi-Fi sensor module 206 platform includes one or more IEEE 802.11-based, wireless sensors, where each wireless sensor comprises a processor system, a memory, a radio frequency communications system, and a battery power system. Generally, the sensors do not rely on any cables, wires, or other harnesses for supplying data or power transmissions. In various aspects, there are no exterior connections to the Wi-Fi sensor module 206 other than through wireless communications via the Wi-Fi wireless access point 208. The Wi-Fi sensor modules 206 are specifically configured to operate under the IEEE 802.11 standard and are configured to monitor the quantities discussed hereinabove, among others. The Wi-Fi sensor modules 206 are powered by battery to avoid wired, cabled, or harnessed connections supplying power to the device.

In one embodiment, the unwired Wi-Fi sensor modules 206 operating under the IEEE 802.11 standard are configured with sensing devices to monitor information particular to the datacenter 202 or equipment located in the datacenter 202 such as the servers 204. For example, the Wi-Fi sensor modules 206 may be located at the air input locations of each and every server 204 on the front rack space area of every equipment rack in the datacenter 202. The selection of the location of the Wi-Fi sensor modules 206 may be determined by and placed in accordance to specifications. Additional Wi-Fi sensor modules 206 may be placed in the input to the computer room air conditioner (CRAC), the output to the CRAC, the area of the room representative of the ambient, and on the exhaust areas of every equipment rack. Failure to instrument any one rack increases the probability that the rack, while operating, to violate a set operating temperature range and cause the equipment to fail.

In one embodiment, one or more Wi-Fi sensor modules 206 may be deployed in the datacenter 202 for collecting the front location air temperature of the equipment racks holding the servers 204. In one aspect, one or more Wi-Fi sensor modules 206 may be located on or in the front rack, side rack, and rear rack areas of every equipment rack in the datacenter 202. Furthermore, one of more of such Wi-Fi sensor modules 206 may be placed on or in the front location of every rack in the datacenter 202 to measure various sense parameters associated with the rack, such as air inlet temperature, electrical current, electrical voltage, electrical power, odor, humidity, light radiation, acoustic, sound, vibration, orientation, distance, geodetic measurements, among others discussed hereinabove. A representative height for the placement of such sensors may be above six feet off the floor of the datacenter 202, in the horizontal center of every equipment rack, below three feet off the floor of the datacenter 202, in the horizontal center of every equipment rack, or in any location desired. A representative placement of the Wi-Fi sensor modules 206 for determining the exit temperature of the equipment racks might be above five feet off the floor of the datacenter 202, in the horizontal center of the rear of every equipment rack, or in any location desired.

In one embodiment, for each rack, a Wi-Fi sensor module 206 may be placed immediately adjacent to the highest server, the lowest server, and the median point between the highest server and the lowest server. In one aspect, three Wi-Fi sensor modules 206 may be employed to provide temperature readings to a remotely located monitoring application 216 that may be accessed via the Internet 214. The monitoring application 216 can receive readings from the highest sensor, the lowest sensor, and the median point sensor and determine the set point temperature according to a selected formula. The formula can also apply weighting to the readings received from each of the Wi-Fi sensor modules 206. For example, a lower weight can be placed with respect to the reading from the highest sensor since it would have the highest temperature. Thus, the set point temperature would be lowered due to the lower weight applied to the highest sensor and thereby resulting in energy cost savings. The placement of a particular Wi-Fi sensor module 206 with respect to the server is also important. A Wi-Fi sensor module 206 can be placed near the air inlet of each respective server 204 since it is the incoming air temperature that would affect the temperature inside the server 204 itself. By determining a number of temperature reading for each rack, the aggregate temperature generated for a specific temperature zone can be calculated and the temperature for that specific zone (instead of the entire area) may be tuned to save energy.

Each of the Wi-Fi sensor modules 206 may be associated with one or more nearby Wi-Fi access points 208 in an existing IEEE 802.11 local wireless network infrastructure, assigned one or more Internet protocol (IP) address, communicated with and managed by one or more remote Wi-Fi compatible dedicated servers or Wi-Fi compatible server applications 216 running on one or more computers.

The entire process allows the monitoring of the data reports from the Wi-Fi sensor modules 206 to be made by the Internet application 216. The Internet application 216 may be referred to as a dashboard application. The Internet application 216 is a computer implemented method for monitoring the Wi-Fi sensor module 206 data reports, analyzing the overall data reports of every Wi-Fi sensor module 206, monitoring the status of every Wi-Fi sensor module 206, compiling the Wi-Fi sensor modules 206 data into useable trend information, and displaying the information intuitively to the manager of the datacenter 202 via a graphical user interface (GUI). The display can also be displayed on any IP-device which is capable of Hypertext Markup Language (HTML) displays. The Internet application 216 is capable of monitoring as well as affecting corrective actions to the datacenter 202 environment. Critical CRAC adjustment decisions can be made based upon these measurements. The CRAC temperature may be adjusted up or down depending upon the results reported. A profile of the datacenter industry metric for Rack Cooling Index (RCI), Return Temperature Index (RTI), Power Usage Effectiveness (PUE), and Datacenter infrastructure Efficiency (DCiE) can then be determined.

Based upon the results of the temperature measurements, the ambient temperature (set point) of the datacenter 202 may be adjusted to accommodate a more efficient setting while ensuring that all equipment racks are operating safely within their operating ranges. Such efficiency mechanisms can save a typical datacenter over seven million pounds of CO₂ per year from being emitted into the atmosphere, and would qualify such datacenter as green.

The Internet application 216 may manage the temperatures continuously or periodically according to a predefined schedule or commands from the Wi-Fi compatible server application running on one or more computers via the existing IEEE 802.11 (Wi-Fi) local wireless network infrastructure and includes an alert system which instructs messages and alarms to be broadcast in a pre-determined sequence of events.

The remote dedicated Wi-Fi compatible servers or Wi-Fi compatible server applications running on one or more computers may reside in the same building as the datacenter 202, in remote locations, in the wireless sensor/actuator deploying enterprises and households, in the location of one or more monitoring and/or controlling service providers, among other locations. The remote dedicated Wi-Fi compatible servers or server applications running on one or more computers may group the Wi-Fi compatible wireless sensor/actuator based on the locations or IP addresses of one or more access points it associated with, its IP address, temperatures or location.

The one or more wireless Wi-Fi sensor modules 206 may include, but are not limited to sensing the quantities described hereinabove and operate using, but not limited to, the IEEE 802.11 wireless local area networks (Wi-Fi). The applications for the Wi-Fi sensor modules 206 may include, but are not limited to, datacenter and building facility, energy conservation, industrial field monitoring and response, wild fire monitoring and response, facility security monitoring and response, building automation, home automation, video surveillance, agriculture monitoring/responding, hazardous gas leakage monitoring/responding, medical equipment and human health engineering.

In one embodiment, the bridge server 210 operates in conjunction with the Wi-Fi sensor modules 206 deployed in the available Wi-Fi wireless environment. In one aspect, the bridge server 210 is configured to perform traffic cop type services to control the data communications flowing from the Wi-Fi sensor modules 206 to the Internet 214. The Wi-Fi sensor modules 206 can be remotely configured and managed using facilities provided by the bridge server 210. The Wi-Fi sensor modules 206, over time, send an enormous amount of valuable sensed data to the Internet application 216 to provide visibility on the health or trouble in any particular area they are deployed. In one aspect, the bridge server 210 can validates all of the data, compiles the data into proper formats, and sends the data in one of many forms, sometime in optimal form, to the Internet 214 host. In the event that the host disconnects, the bridge server 210 can store the Wi-Fi sensor modules 206 data for an extended period of time, such as, for example, hours, days, weeks, months, years, until the connection is restored. In this manner, valuable data generated by the Wi-Fi sensor modules 206 can be preserved.

In one embodiment, the bridge server 210 provides local management of the Wi-Fi sensor modules 206 configuration, data, networking, and traffic. In addition, the bridge server 210 may be configured to auto-discover all the Wi-Fi sensor modules 206 located in its vicinity and to maintain connectivity and local administration. In one aspect, the bridge server 210 may be configured to identify the types of Wi-Fi sensor modules 206 deployed in the network and to validate proper system parameters. The bridge server 210 also may be configured to optimize and consolidate the data transmitted by the Wi-Fi sensor modules 206 to the Internet 214 host and to manage the connection between the Internet 214 host and the Wi-Fi sensor modules 206 using secure SNMP. In one aspect, the bridge server 210 also can be configured to continuously monitor the transmission quality of the Wi-Fi sensor modules 206 and conformance in the system. In one aspect, the bridge server 210 can be pre-programmed and configured to directly manage the Wi-Fi sensor modules 206 and to operate in conjunction with common, off-the-shelf, Wi-Fi access point routers.

In one embodiment, the bridge server 210 may comprise a processor, memory, disk storage, and an operating system. The processor may operate at any suitable speed and in one embodiment the processor operates at about 1 GHZ. The memory may be any suitable size and in one embodiment the bridge server 210 has about 2 GB of memory and a storage disk size of about 250 GB. Any suitable operating system may be employed as the underlying operating system software and in one embodiment the Linux operating system may be employed. In other embodiments, any operating system software, consisting of programs and data that run on computers and manage computer hardware resources and provide common services for efficient execution so various application software may be employed. Popular modern operating systems that may be employed in the bridge server 210 include, without limitation, Microsoft® Windows®, Mac® OS X, GNU/Linux, and Unix, for example.

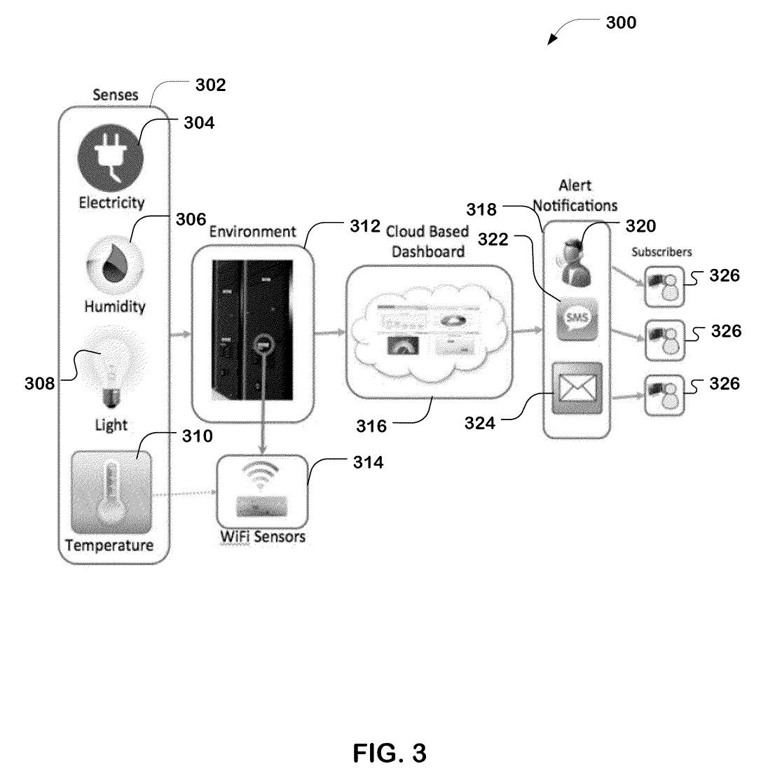

FIG. 3 illustrates one embodiment of a system 300 for monitoring a datacenter 312. In one embodiment, an apparatus that employs specifically configured IEEE 802.11-based wireless sensors 314 (Wi-Fi sensor modules) for monitoring various conditions in the datacenter 312 is disclosed. In the embodiment illustrated in FIG. 3, the system 300 comprises one or more Wi-Fi sensor modules 314 to sense various parameters associated with the datacenter 312 referred to herein as senses 302. The Wi-Fi sensor modules 314 may be configured to sense electricity 304, humidity 306, light 308, and temperature 310, among others, for example, such as those quantities discussed hereinabove. The one or more Wi-Fi sensor modules 314 are deployed in the datacenter 312 to monitor conditions therein. As described in connection with FIGS. 1 and 2, the Wi-Fi sensor modules 314 transmit the sensed information over the Internet to a cloud based dashboard 316. Alert notifications 318 associated with the datacenter 312 may be provided to subscribers 326 by telephone 320, short message service 322 (SMS), e-mail 324, or any combination thereof.

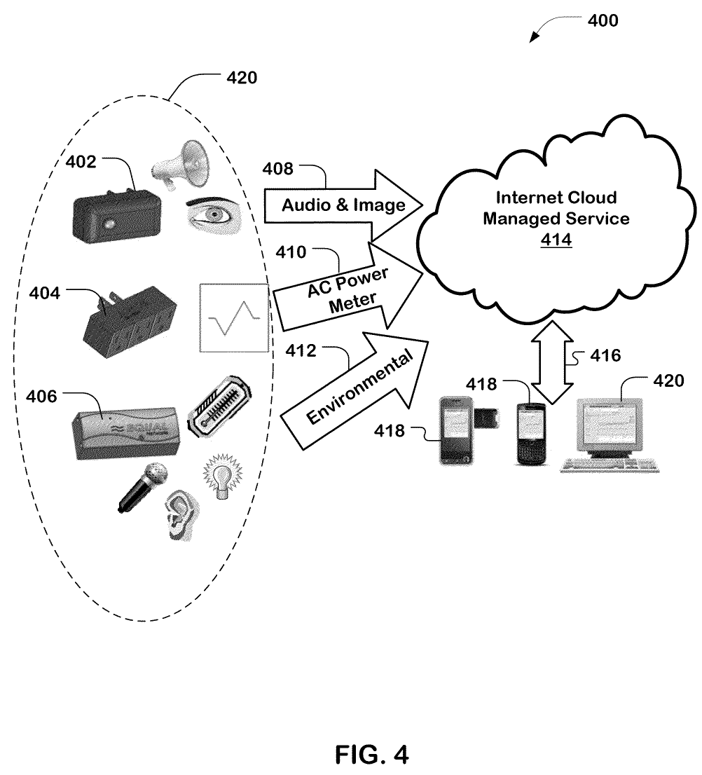

FIG. 4 illustrates one embodiment of a system 400 for monitoring a datacenter 420. In one embodiment, various IEEE 802.11-based wireless sensors (Wi-Fi sensor modules) are used for monitoring various conditions in the datacenter 420. In the embodiment illustrated in FIG. 4, the system 400 comprises a multimedia Wi-Fi sensor module 402 for sensing audio and image (still and/or moving, video, etc.) information associated with the datacenter 420 and wirelessly transmitting the audio and image information 408 to an Internet cloud managed service 414 for datacenter management purposes. The system 400 also may comprise an AC metering Wi-Fi sensor module 404 for measuring AC power consumed by equipment located in the datacenter 420. The AC metering Wi-Fi sensor module 404 may be configured to sense electrical resistance, electrical current, electrical voltage, electrical power, among other quantities. The AC power meter information 410 may be wirelessly transmitted to the Internet cloud managed service 414 for datacenter management purposes. The system 400 also may comprise an environmental Wi-Fi sensor module 406 for measuring environmental conditions in the datacenter 420 such as sense parameters, which may include, but are not limited to temperature, heat, magnetism, pressure, gas and liquid flow, gas and liquid volume, odor, viscosity and density, humidity, chemical proportion, light, time-of-flight, infrared, proximity, radiation, subatomic particle, hydraulic, acoustic, motion, vibration, orientation, distance, biological, geodetic. The environmental information 412 may be wirelessly communicated to the Internet cloud managed service 414 for datacenter 420 management purposes. Once the audio/image information 408, AC power meter information 410, and/or environmental information 412 is wirelessly communicated to the to the Internet cloud managed service 414, the data can be accessed by any IP enabled wireless device 418 or computer 420 in communication 416 with the Internet cloud managed service 414. Thus, the datacenter 420 can be managed from anywhere where the Internet can be accessed and at any time on any IP enabled device.

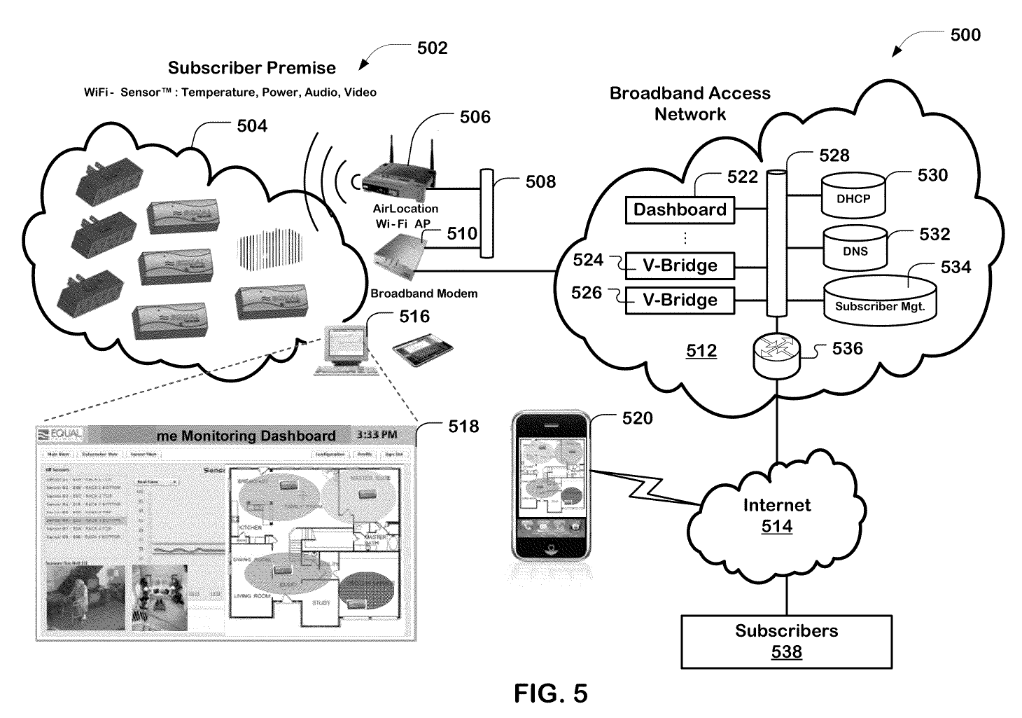

FIG. 5 illustrates one embodiment of a system 500 for monitoring a subscriber premise 502 (e.g., a datacenter). In one embodiment, a network of IEEE 802.11-based wireless sensors 504 (Wi-Fi sensor modules) are configured for monitoring various conditions in the subscriber premise 502. The Wi-Fi sensor modules 504 are configured for sensing audio and image (still and/or moving, video, etc.) information, AC metering such as electrical resistance, electrical current, electrical voltage, electrical power, among others, and environmental sense parameters, which may include, but are not limited to temperature, heat, magnetism, pressure, gas and liquid flow, gas and liquid volume, odor, viscosity and density, humidity, chemical proportion, light, time-of-flight, infrared, proximity, radiation, subatomic particle, hydraulic, acoustic, motion, vibration, orientation, distance, biological, geodetic. The Wi-Fi sensor modules 504 communicate wirelessly with a Wi-Fi access point 506, which is in communication with a broadband modem 510 through a network 508. The broadband modem 510 is in communication with a broadband access network 512 where the data collected by the Wi-Fi sensor modules 504 can be analyzed. Once the sensor data is transmitted to the broadband access network 512 it can be accessed by any IP enabled mobile device 520 or computer 516 via the Internet 514. The computer 516 and/or mobile device 520 can access a dashboard application 522, or other computer implemented method, for monitoring the subscriber premises 502 from any location that access the Internet. The dashboard application 522 provides a screen display 518 which provides the necessary monitoring information to the user.

In one embodiment, the broadband access network 512 comprises a dashboard application 522 for analyzing and displaying the dashboard screen 518 information on remote computers 516 or mobile devices 520. The dashboard application 522 and one or more V-Bridges 524, 526 are coupled via network 528. Also coupled to the network 528 are a plurality of databases such as a dynamic host configuration protocol (DHCP) database 530, domain name system (DNS) database 532, and a subscriber management database 534. The network 528 is coupled to the Internet via a router 536. Information can be transmitted from the broadband access network 512 to subscribers 538 via the Internet 514 through the router 536.

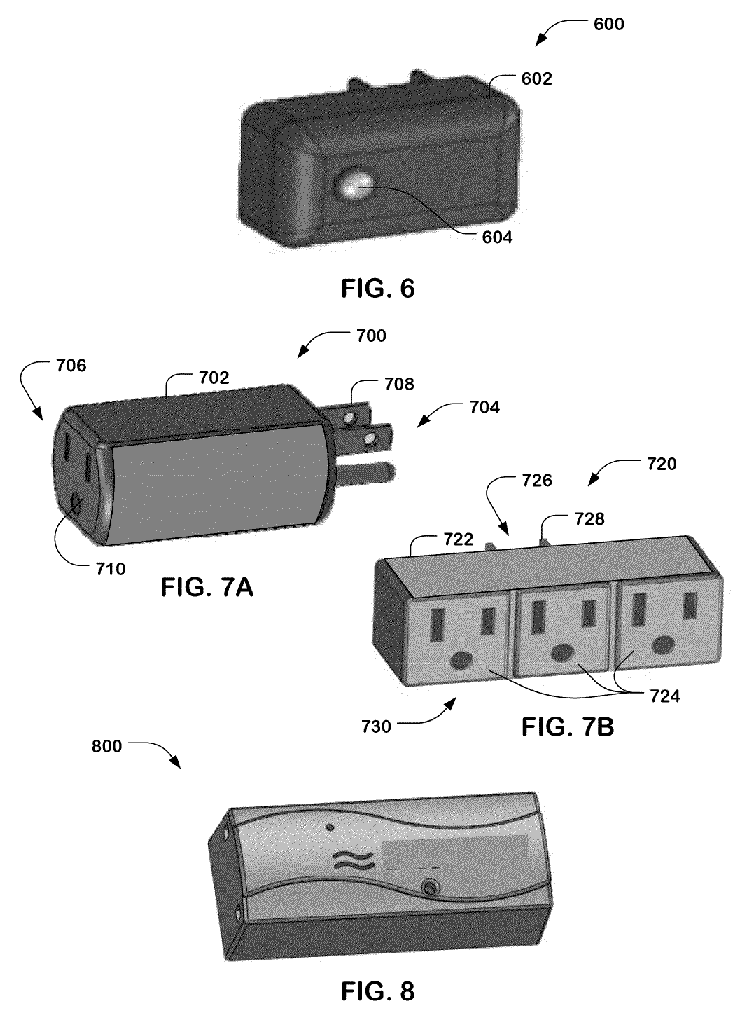

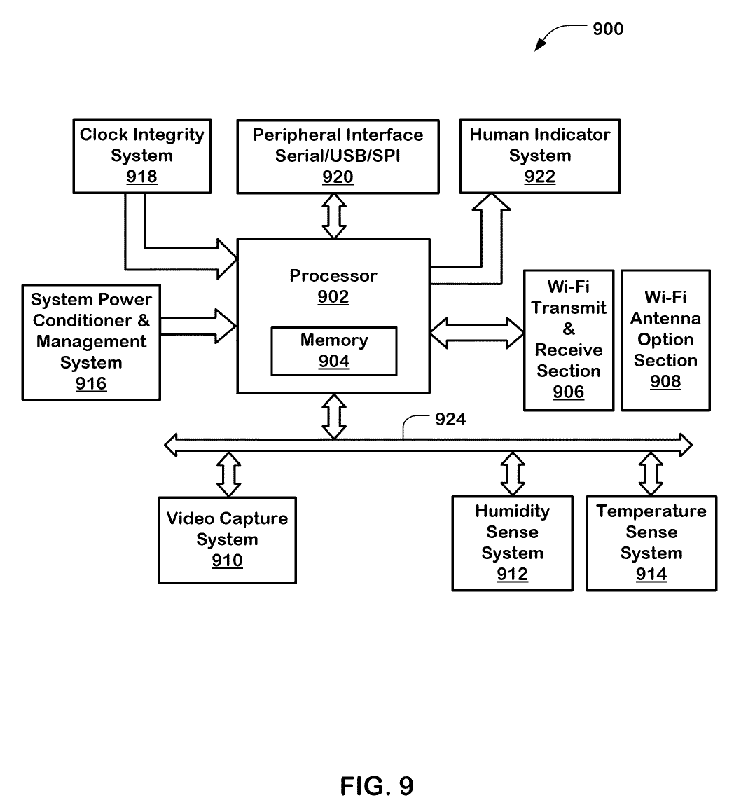

FIG. 6 illustrates one embodiment of a video capture Wi-Fi sensor module 600. The video capture Wi-Fi sensor module 600 may be employed in any of the datacenter monitoring systems 100, 200, 300, 400, 500 (FIGS. 1-5) described hereinabove. In addition to the video capture system, the Wi-Fi sensor module 600 may include additional functionality such as audio, still image capture, humidity sense system, and/or a temperature sense system, among others. In the embodiment illustrated in FIG. 6, the video capture Wi-Fi sensor module 600 comprises a housing 602 suitable for installation on datacenter equipment such as: data storage equipment, information processing equipment, servers, host servers, web servers, Internet servers, enterprise-based servers, computer systems and associated components, telecommunications systems, redundant or backup power supplies, redundant data communications connections, environmental controls (e.g., air conditioning, fire suppression), and security devices, among others. An optical element 604 is coupled to an image sensor and image processing hardware and software to render the captured images into a video. A functional block diagram of the video capture Wi-Fi sensor module 600 is shown in FIG. 9.

Turning now to FIG. 9, where a functional block diagram 900 of the video capture Wi-Fi sensor module 600 is illustrated. With reference now to both FIGS. 6 and 9, the video capture Wi-Fi sensor module 600 comprises a processor 902, a memory 904, and a radio frequency communications system comprising a Wi-Fi transmit/receive section 906 (transceiver section) and a Wi-Fi antenna option section 908. A video capture system 910 is coupled to the processor 902 and memory 904 via internal bus 924. The processor 902 and the memory 904 are coupled to the Wi-Fi transmit/receive section 906, which is coupled to the Wi-Fi antenna 908.

In one embodiment, the video capture system 910 comprises an image sensor, which is a device for converting an optical image into an electric signal as is generally used in digital cameras and other digital imaging devices. In one embodiment, the image sensor comprises either a charge-coupled device (CCD) or a complementary metal-oxide-semiconductor (CMOS) active pixel sensor to capture light and convert it to an electrical signal. Since a CCD is an analog device, when light strikes the chip it is held as a small electrical charge in each photo sensor. The small charges are converted to voltage one pixel at a time as they are read from the chip. Additional circuitry in the video capture system 910 converts the voltage into digital information. A CMOS chip is a type of active pixel sensor made using the CMOS semiconductor process. Extra circuitry next to each photo sensor converts the light energy to a voltage. Additional circuitry on the video capture system 910 may be included to convert the voltage to digital data. As the images are captured by the video capture system 910 they are processed by the processor 902, stored in the memory 904, and are wirelessly transferred by the Wi-Fi transceiver section 906 over the antenna 908.

Still with reference to FIGS. 6 and 9, in one embodiment, the video capture Wi-Fi sensor module 600 also comprises a system power conditioning and management system 916, a clock integrity system 918, a peripheral interface 920, such as a serial, USB, or SPI, and a human indicator system 922 all coupled to the processor 902 and the memory 904. In addition to the video capture system 910, the video capture Wi-Fi sensor module 600 also may comprise a humidity sense system 912 and/or a temperature sense system 914.

Data gathered with the video capture system 910, humidity sense system 912, and temperature sense system 914 can be transmitted over the Wi-Fi transceiver section 906 and antenna 908 over a Wi-Fi wireless network as described hereinabove in connection with systems 100, 200, 300, 400, 500 of respective FIGS. 1-5.

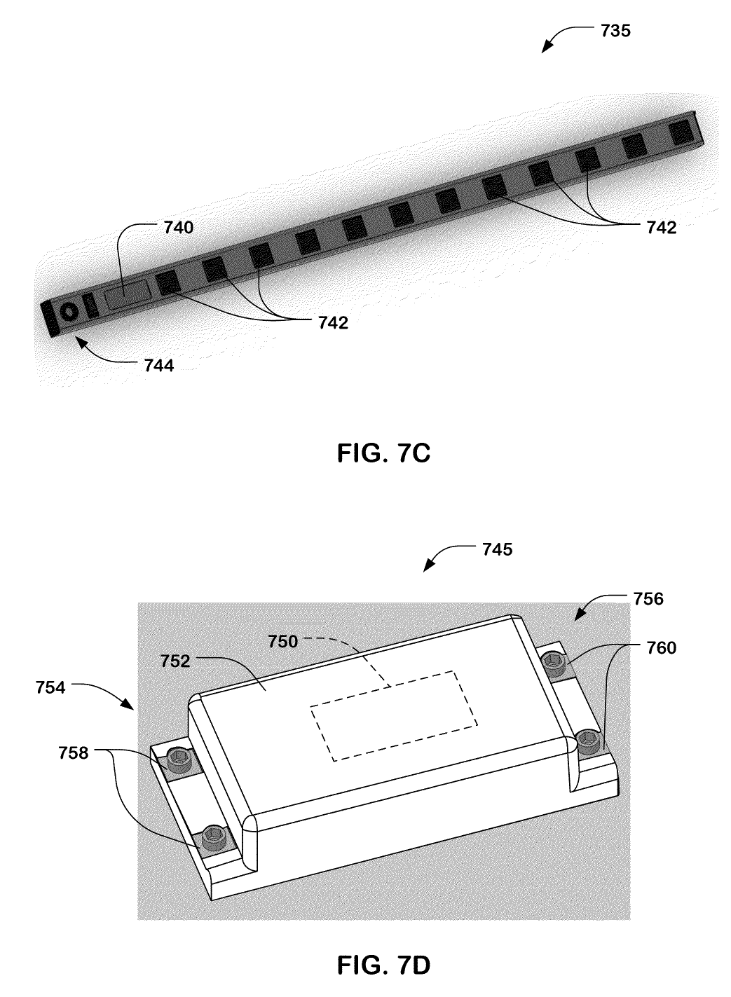

FIGS. 7A and 7B illustrate various embodiments of an AC power meter Wi-Fi sensor module 700, 720, respectively, for AC power metering and IEEE 802.11 (Wi-Fi) compatible communication capabilities, among other functions described hereinbelow. The AC power meter Wi-Fi sensor modules 700, 720 are intelligent electronic modules capable of controlling and/or monitoring the AC electrical power being fed to any device that uses AC electrical power. In one embodiment, the AC power meter modules 700, 720 each comprise a housing comprising an inlet plug suitable for connection to an alternating current (AC) power source and at least one receptacle suitable receiving an AC plug connected to a load equipment, an AC power measurement module, and a Wi-Fi communication module. In one embodiment, the AC power meter Wi-Fi sensor modules 700, 720 each comprise a control module to control the operation of the device connected to the AC power meter Wi-Fi sensor modules 700, 720. The AC power meter Wi-Fi sensor modules 700, 720 may be employed for easily measuring the AC power consumed by datacenter equipment. The AC power consumption of the entire datacenter may be measured by placing AC power meter Wi-Fi sensor modules 700, 720 in the AC plug input of every rack in the datacenter. The selection of the location of the AC power meter Wi-Fi sensor modules 700, 720 is determined, placed, and monitored.

FIG. 7A illustrates one embodiment of a single in-line AC power meter module 700. The AC power meter Wi-Fi sensor module 700 comprises a single in-line housing 702 with a single outlet to enable a single electrical device which use alternating current as a power source to be plugged in. In one embodiment, the AC power meter Wi-Fi sensor module 700 is an intelligent, self-contained AC current, AC voltage, and power factor sensor that operates in accordance with IEEE 802.11b (Wi-Fi) for wireless communications to the Internet. The housing 702 comprises a first end 704 and a second end 706 and contains a circuit board (not shown) with functional electronic components within the housing 702. The first end 704 of the AC power meter Wi-Fi sensor module 700 comprises a standard AC power plug 708 suitable for connecting the AC power Wi-Fi sensor module 700 into a standard AC power receptacle. The second end 706 comprises a standard AC power receptacle 710 suitable for the load equipment to plug into. The inlet plug 708 is generally configured to couple to an AC outlet where a first Leg A supplies 120 VAC (volts of alternating current) relative to a neutral supply. A second Leg B also supplies 120 VAC relative the neutral supply, but the AC voltage is 180 degrees out of phase with Leg A, so there is 240 VAC between Leg A and Leg B.

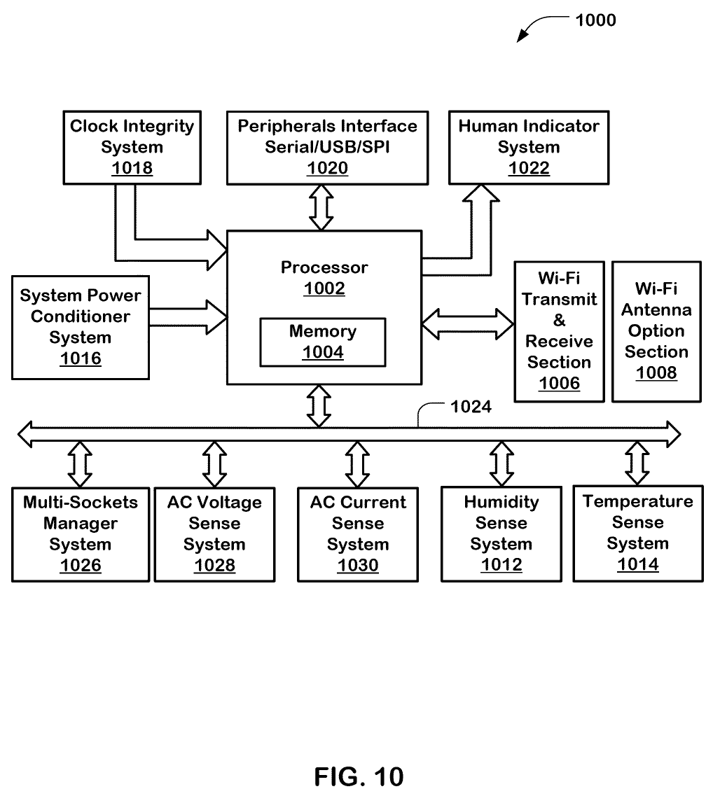

In one embodiment, the AC power meter Wi-Fi sensor module 700 may comprise an International Electrotechnical Commission (IEC) standard power cord over molded into the housing 706. The inlet power plug 708 and the outlet receptacle 710 may be configured to conform to one of any internationally accepted configurations and designs for the shape and size of the connectors used for connecting electrical loads to AC power. Accordingly, the embodiments of the AC power meter Wi-Fi sensor module 700 should not be limited to the form factor shown and described in connection with FIG. 7A. The AC plug 708 and the receptacle 710 portions of the AC power meter Wi-Fi sensor module 700 are in complementary male/female pair matched to the respective connectors coming from the AC power source and going to the AC electric load. The AC power meter Wi-Fi sensor module 700 is configured to be plugged into the inlet alternating current power source and to receive an AC electrical load. The functional circuitry for controlling and/or monitoring the electrical power being fed into any load equipment that uses AC current power is contained within the housing 702 and is described in FIG. 10.

Turning now to FIG. 7B, where one embodiment of an AC power meter Wi-Fi sensor module 720 in the form of a power strip with multiple outlets to enable multiple devices to be plugged in is illustrated. In one embodiment, the AC power meter Wi-Fi sensor module 720 is an intelligent, self-contained AC current, AC voltage, and power factor sensor that operates in accordance with IEEE 802.11b (Wi-Fi) for wireless communications to the Internet. The AC power meter Wi-Fi sensor module 720 enables measurement, in real-time, of total current, voltage, and power factor used by devices and equipment plugged into its outlets 724. The plug 728 runs continuously and can be located up to 100 meters from any common Wi-Fi access point. In various embodiments, the AC power meter Wi-Fi sensor module 720 may be specifically configured to operate in home or industrial environments.

In one embodiment, the AC power meter Wi-Fi sensor module 720 may be combined with Internet dashboard applications (computer implemented methods as discussed hereinabove) to continuously monitor sensor data from any IP-Device, at anytime, anywhere on the Internet as a service. In one embodiment, the AC power meter Wi-Fi sensor module 720 can directly connect to a Wi-Fi access point and is compliant with the IEEE 802.11b/g performance and protocol. In one embodiment, the AC power meter Wi-Fi sensor module 720 can communicate at a data rate of approximately 2-11 Mbps at 2.4 GHZ, ISM unlicensed band. The Internet Protocols include simple network management protocol (SNMP), address resolution protocol (ARP), user datagram protocol (UDP), transmission control protocol/Internet protocol (TCP/IP). Data Security (encryption) includes all IEEE 802.11 security modes available such as wired equivalent privacy (WEP), wireless application protocol (WAP), Wi-Fi protected access (WPA), Wi-Fi protected access II (WPA2). Sensor control is direct “Over-the-air” adjustable sample rate and other parameters using SNMP and provides automatic discovery and reporting over Wi-Fi. The AC power meter Wi-Fi sensor module 720 is also configured to communicate with cloud-based dashboard management software applications.

In various embodiments, the AC power meter Wi-Fi sensor module 720 is packaged inside a National Electrical Manufacturers Association (NEMA) standard power strip housing 722 containing from 1 to 20 power outlets 724. In the embodiment illustrated in FIG. 7B, the AC power meter Wi-Fi sensor module 720 comprises a first end 726 comprising a single AC power plug 728 and a second end 730 comprising multiple (three) outlets 724 to enable up to three AC electrical power devices to be plugged in. In one embodiment, the AC power meter Wi-Fi sensor module 720 input is NEMA-5-15P compatible and the output is NEMA-5-15R compatible. In one embodiment, the housing 722 has dimensions of approximately 90 mm×40 mm×30 mm (3.6″×1.5″×1.2″). The AC input can be approximately 100-250 VAC±10%, 50/60 Hz. The power meter accuracy is I_{RMS}, V_{RMS} with a power factor accuracy of approximately less than 1% and meter-able. The sample period may be user selectable with a default setting of 60 samples per minute. The transmission range is approximately 100-150 meters omni-directional. The housing 722 contains functional circuitry for controlling and/or monitoring the electrical power being fed into any load equipment that use AC electrical power and is plugged into the AC power meter Wi-Fi sensor module 720, as discussed in more detail hereinbelow in connection with FIG. 10.

FIG. 7C illustrates one embodiment of an AC power meter Wi-Fi sensor module 740 embedded in a power strip 735 with multiple outlets 742 to enable multiple devices to be plugged in. The power strip 735 receives AC input at end 744, which is coupled to the input of the AC power meter Wi-Fi sensor module 740. The AC output of the AC power meter Wi-Fi sensor module 740 is wired to the multiple outlets 742. In one embodiment, the AC power meter Wi-Fi sensor module 740 is an intelligent, self-contained AC current, AC voltage, and power factor sensor that operates in accordance with IEEE 802.11b (Wi-Fi) for wireless communications to the Internet. The AC power meter Wi-Fi sensor module 740 enables measurement, in real-time, of total current, voltage, and power factor used by devices and equipment plugged into its outlets 742.

FIG. 7D illustrates one embodiment of an AC power meter Wi-Fi sensor module 750 embedded in a power block 745. The power block 745 comprises a housing 752 to contain the AC power meter Wi-Fi sensor module 750. The power block 745 has an AC input side 754 and an AC output side 756 and the AC power meter Wi-Fi sensor module 750 is coupled therebetween. The AC input side comprises a first set of terminals 758 to connect to AC power from the building mains. The AC output side comprises a second set of terminal 760 and is connected to the AC input of a device. In one embodiment, the AC power meter Wi-Fi sensor module 750 is an intelligent, self-contained AC current, AC voltage, and power factor sensor that operates in accordance with IEEE 802.11b (Wi-Fi) for wireless communications to the Internet. The AC power meter Wi-Fi sensor module 750 enables measurement, in real-time, of total current, voltage, and power factor used by devices and equipment plugged into its output terminals 760.

With reference now to FIGS. 7A-D, the AC power meter Wi-Fi sensor modules 700, 720, 740, 750 are configured to be inserted between an AC power source and a load. The AC power meter Wi-Fi sensor modules 700, 720, 740, 750 accept on one side of the circuit board, an AC power inlet connection and on the other side provide an AC power receptacle or outlet connection for the load to plug into. In between the two connections, the AC power meter Wi-Fi sensor modules 700, 720, 740, 750 intelligently monitor and/or control the AC power delivered to the load. The intelligence provides a system-wide controlling element to send and receive commands and status information from the AC power meter Wi-Fi sensor modules 700, 720, 740, 750. A functional description of the AC power meter Wi-Fi sensor modules 700, 720, 740, 750 is provided hereinbelow in connection with FIG. 10.

FIG. 10 is a functional block diagram 1000 of the AC power meter Wi-Fi sensor modules 700, 720, 740, 750. With reference now to FIGS. 7A, 7B, and 10, in one embodiment, the AC power meter Wi-Fi sensor modules 700, 720, 740, 750 each comprise a processor 1002, a memory 1004, and a radio frequency communications system comprising a Wi-Fi transmit/receive section 1006 (transceiver) and a Wi-Fi antenna option section 1008. The AC power meter Wi-Fi sensor modules 700, 720, 740, 750 plug into a standard wall duplex outlet, or other AC outlets, or AC power buss strips, and allows the power used by any AC power consuming device connected to it, to be measured and transmitted over the local Wi-Fi network.

In one embodiment, the AC power meter Wi-Fi sensor modules 700, 720, 740, 750 each comprise a control module comprising a multi-sockets manager system 1026 and an AC power measurement module comprising an AC voltage sense system 1028 and an AC current sense system 1030. These modules are coupled to the processor 1002 and the memory 1004 through an internal bus 1024. The multi-sockets manager system 1026 controls devices plugged into the multiple sockets 724 (FIG. 7B). The AC voltage sense system 1028 and the AC current sense system 1030 measure the AC voltage at the load and the AC current flowing between the plug and the receptacles or sockets. An analog to digital (A/D) converter converts the measured quantities and provides digitized measurements of AC voltage and current to the processor 1002 and can be stored in the memory 1004. The digitized AC voltage/current measurement samples are provided to the Wi-Fi transmit and receive section 1006, which wirelessly transmits the measurement samples via the Wi-Fi antenna section 1008.

In one embodiment, the functional block diagram 1000 represents a digital solid state electric power usage meter for determining power usage by a load attached to an electric power network. The AC current sense system 1030 comprises a current sensor coupled to each phase of the electric power network for sensing current in each phase. The AC voltage sense system 1028 comprises a voltage divider coupled to each phase of the power network for detecting the voltage level on each phase. The A/D converter is coupled to the current sensors and voltage dividers and receives signals from the current sensors related to the current in each phase and signals from the voltage dividers related to the voltage on each phase. The A/D converter samples the current and voltage related signals at predetermined times at a rate which insures that samples of the current and voltage related signals do not repeat for a large number of cycles of the network frequency or never repeat and which rate is at least twice as fast as the rate of change of the current and voltage related signals and converts the samples to digital signals representing the voltage levels and current at the predetermined times. The processor 1002 calculates instantaneous values of power at the predetermined times from the digital signals and the memory 1004 accumulates the instantaneous values so as to form a value representative of electric power usage by the load attached to the network.

In one aspect, for example, the AC power meter Wi-Fi sensor modules 700, 720, 740, 750 may be configured for a typical 3-wire, 240 volt single phase electrical service. Those ordinarily skilled in the art can easily adapt the disclosed embodiment for other electrical services. In such as system, a first Leg A supplies 120 VAC (volts of alternating current) relative to a neutral supply 102. A second Leg B also supplies 120 VAC relative the neutral supply, but the AC voltage is 180 degrees out of phase with Leg A, so there is 240 VAC between Leg A and Leg B.

In one embodiment, the AC current sense system 1030 comprises a first current sensor coil element to produce a first set of differential signals that are proportional to the AC current in a first leg (Leg A) of the inlet plug and are suitable for input to an A/D converter, for example, and a second current sensor coil element to produce a second set of differential signals that are proportional to the AC current in a second leg (Leg B) of the inlet plug and are also suitable for input to the A/D converter. The AC voltage sense system 1028 comprises voltage sensor networks comprising a first set of resistors to divide the voltage between the first leg (Leg A) and neutral to produce a first differential voltage signal suitable for input to the A/D converter and a second set of resistors to divide the voltage between the second leg (Leg B) and neutral to produce a second differential voltage suitable for input to the A/D converter.

In one embodiment, the AC power meter function may be performed by a power integrated circuit (IC) designed specifically for use in utility power meters. Several suitable commercial products are readily available such as, for example, part number CS5467 provided by Cirrus Logic, Inc. (www.cirrus.com), 2901 Via Fortuna, Austin, Tex. 78746. Power IC 120 contains analog conditioning circuits and a 16-bit, 4-channel analog-to-digital converter for converting the sensed current and voltage signals into numerical values. The power IC also contains digital processing circuits for providing various measures of power and characteristics of the voltage and current sensed in Leg A and Leg B. The sampling rate may be about 4000 samples per second, or about 67 samples per cycle of 60 Hertz power, for example.

The power IC may be configured to provide electrical parameters as 24-bit quantities (3 bytes) to ensure that 16-bit accuracy of the A/D conversion is carried throughout the calculations.

In one embodiment, a single chip programmable preprocessor with sufficient processing capacity to read the electrical parameters from the power IC, process and characterize the electrical parameters, and then prepare reports that transfer information to the processor 1002 may be employed. Several manufacturers provide several products that are suitable for this purpose such as, for example, model PIC24HJ128GP202 provided by Microchip Technology Inc. (www.microchip.com), 2355 West Chandler Blvd., Chandler, Ariz.

The processor 1002 may be a general purpose processor or a specialized processor used in an energy management system. The processor 1002 either includes a large data memory or is coupled to the memory 1004 to store reports from the preprocessor or the digitized samples from the A/D converter, depending on the particular implementation.

Some embodiments may combine the functions of the preprocessor, the processor 1002, and the memory 1004 into a single processor or single circuit generally known as a microcontroller. This can be easily accomplished by those ordinarily skilled in the art of circuit design and programming. This particular implementation of combination of functions is anticipated. In addition, advances in technology or application requirements may enable and/or require additional and/or other combinations of functions. The latter implementation of combination of functions also is anticipated.

Each of the AC power meter Wi-Fi sensor modules 700, 720, 740, 750 also may comprise a humidity sense system 1012 and/or a temperature sense system 1014. Various other embodiments of the AC power meter Wi-Fi sensor modules 700, 720, 740, 750 may comprise, in any combination, all or some of these additional sense systems, without limitation: heat, electrical resistance, DC electrical current, DC electrical voltage, AC/DC electrical power, magnetism, pressure, gas and liquid flow, gas and liquid volume, odor, viscosity and density, chemical proportion, light, time-of-flight, image, infra-red, proximity, radiation, subatomic particle, hydraulic, acoustic, sound, motion, vibration, orientation, distance, biological, or geodetic measurements, among others, for example. For example, in one embodiment, the AC power meter Wi-Fi sensor modules 700, 720, 740, 750 also comprise a system power conditioning and management system 1016, a clock integrity system 1018, a peripheral interface 1020, such as a serial, universal serial bus (USB), or serial peripheral interface (SPI), and a human indicator system 1022 all coupled to the processor 1002 and the memory 1004.

In one embodiment, the wireless RF communications functionality of the AC power meter Wi-Fi sensor modules 700, 720, 740, 750 adheres to the IEEE 802.11b/g requirements and is compliant in the PHY layer as well as the network layer protocols. The AC power meter Wi-Fi sensor modules 700, 720, 740, 750 contain other electronic circuitry and intelligence capable of measuring AC current being drawn through the connector outlet 710, 724 742 or terminal 760 as well as the AC voltage across the outlet terminals, and wirelessly communicating that information back to a centrally located system-wide processing element as discussed in connection with the systems 100, 200, 300, 400, and 500 in respective FIGS. 1-5. The system-wide processor stores the information sent and displays the information sent on a form useable for monitoring and controlling the AC power to the electrical load installed into the AC power meter Wi-Fi sensor modules 700, 720, 740, 750.

The on-board processor 1002 is capable of monitoring as well as switching the alternating current power outlet portion of the AC power meter Wi-Fi sensor module in an ON state or an OFF state based on digital commands that are sent to the AC power meter Wi-Fi sensor modules 700, 720, 740, 750 wirelessly via Wi-Fi. The commands are received, processed, and then acknowledged back by the on-board processor 1002. The command sent/acknowledgement functionality ensures against erroneously sent commands or incorrectly interpreted by the AC power meter Wi-Fi sensor modules 700, 720, 740, 750. This ensures that the AC power to a particular electrical load connected to the AC power meter Wi-Fi sensor modules 700, 720, 740, 750 is turned “OFF” or “ON” when it is intended to be turned “OFF” or “ON.” A power control and monitoring network may be built by deploying a plurality of the AC power meter Wi-Fi sensor modules 700, 720, 740, 750 onto each device that uses AC electrical power, each Wi-Fi wirelessly monitored and controlled by a central system-wide processor element.

In one embodiment, without limitation, IEEE 802.11 compatible wireless AC power meter sensor modules in accordance with the present specification may be provided in the package of a power strip with one or many power outlets. Such modules comprise a plug configured to connect to an AC power source and receptacles are configured to receive the plugs of any devices/equipment located in a datacenter for measuring the AC power usage information of the device/equipment plugged into the wireless sensor AC power meter Wi-Fi sensor module. In other embodiments, IEEE 802.11 compatible wireless AC power meter sensor modules may be formed integrally with the equipment power cord. In accordance with the disclosed embodiments, the present specification provides the concept of wirelessly reporting AC current and voltage usage information through a wireless communications network similar to the systems 100, 200, 300, 400, 500 of respective FIGS. 1-5, for example.

In one embodiment, without limitation, for example, the AC power meter Wi-Fi sensor module 700, 720, 740, 750 may be provided in a variety of form factors such as those shown in FIGS. 7A-D. As shown in FIG. 7A, for example, the AC power meter Wi-Fi sensor module 700 comprises a single in-line connector plug 708. The connector plug 708 plug is configured to connect to an AC power source. The receptacle 710 is configured to receive the plug of any device/equipment located in a datacenter for measuring the AC power usage information of the device/equipment plugged into the wireless sensor AC power meter Wi-Fi sensor module 700. In accordance with the disclosed embodiment, the present specification provides the concept of wirelessly reporting AC current and voltage usage information through a wireless communications network as described in connection with wireless systems 100, 200, 300, 400, 500 of respective FIGS. 1-5, for example.

In one embodiment, without limitation, as shown in FIG. 7B, for example, the AC power meter Wi-Fi sensor module 720 may be provided in the package of an equipment power cord, commonly referred to as IEC-standard plug cord, and comprises a single plug 728 configured to connect to an AC power source. The receptacles 724 are configured to receive the plugs of any devices/equipment located in a datacenter for measuring the AC power usage information of the device/equipment plugged into the wireless sensor AC power meter Wi-Fi sensor module 720. In accordance with the disclosed embodiment, the present specification provides the concept of wirelessly reporting AC current and voltage usage information through a wireless communications network similar to the systems 100, 200, 300, 400, 500 of respective FIGS. 1-5, for example.

In various other embodiments, without limitation, as shown in FIGS. 7C and 7D, the AC power meter Wi-Fi sensor module 720 may be provided in a power strip 735 with multiple outlets 742 or embedded in a power block 745.

Each of the IEEE 802.11 based AC power meter Wi-Fi sensor modules 700, 720, 740, 750 receptor may be associated with one or more nearby Wi-Fi access points in an existing IEEE 802.11 local network infrastructures, assigned one or more IP address, communicated with and managed by one or more remote Wi-Fi compatible dedicate servers or Wi-Fi compatible server applications running on one or more computers similar to the systems 100, 200, 300, 400, 500 shown and described in connection with respective FIGS. 1-5, for example.

In one embodiment, a method provides monitoring each IEEE 802.11 based AC power meter Wi-Fi sensor modules 700, 720, 740, 750 by an Internet dashboard application (110, 216, 316, 414, 522 of respective FIGS. 1-5, as discussed hereinabove generally, for example, and as described in one particular embodiment hereinbelow in connection with FIGS. 12-21, for example). In one aspect, the Internet dashboard application is a computer implemented method for monitoring the Wi-Fi sensor modules 700, 720, 740, 750 deployed throughout a wireless local area network, reporting, analyzing the information received from the sensors, monitoring every the status of the sensors, compiling the AC power meter Wi-Fi sensor modules 700, 720, 740, 750 data into useable trend information, and displaying this information intuitively to a datacenter manager on a Graphical User Interface (GUI). This display can also be displayed on any IP-device which is capable of HTML displays. The Internet dashboard application is capable of monitoring as well as affecting corrective actions to the equipment located in the datacenter and plugged into an AC power meter Wi-Fi sensor modules 700, 720, 740, 750. Critical equipment operational adjustment decisions can be made based upon these measurements. The information contained in the reports received from the AC power meter Wi-Fi sensor modules 700, 720, 740, 750 is used by the Internet application to profile the datacenter in accordance with important industry metrics defined by organizations such as RCI, RTI, PUE, and DCiE. For example, the AC power meter Wi-Fi sensor modules 700, 720, 740, 750 can be employed to measure and collect data to enable the dashboard application to accurately calculate the IT load of equipment located in the datacenter.

Based upon the results of the measurements, the electrical usage of the datacenter may be adjusted to accommodate more efficient operating ranges. Such efficiency mechanisms can save a typical datacenter over 15 million pounds of CO₂ per year from being emitted into the atmosphere, and qualifies for a green datacenter, for example.

The Internet dashboard application (110, 216, 316, 414, 522 of respective FIGS. 1-5, as discussed hereinabove generally, for example, and as described in one particular embodiment hereinbelow in connection with FIGS. 12-21, for example) can be employed to manage the temperatures continuously or periodically according to a predefined schedule or commands from the Wi-Fi compatible server application running on one or more computers in an existing IEEE 802.11 (Wi-Fi) local wireless network infrastructure. In one aspect, the Internet dashboard includes an alert system which instructs message and alarms to be communicated in a pre-determined sequence of events.

The remote dedicated Wi-Fi compatible servers or Wi-Fi compatible server applications running on one or more computers may reside in the same building as the datacenter, in remote locations in a wireless network deployed in enterprises or households, or in the location of one or more monitoring and/or controlling service provider locations. The remote dedicated Wi-Fi compatible servers or server applications running on one or more computers may group the Wi-Fi compatible wireless sensor/actuator based on the locations or IP addresses using one or more access points it associates with, its IP address, temperatures or location.

In various embodiments, the AC power meter Wi-Fi sensor modules 700, 720, 740, 750 may be configured to sense, without limitation: temperature, heat, electrical resistance, electrical current, electrical voltage, electrical power, magnetism, pressure gas and liquid flow, gas and liquid, odor, viscosity and density, humidity, chemical proportion, light time-of-flight, light, image, infra-red, proximity, radiation, subatomic particle, hydraulic, acoustic, sound, motion, vibration, orientation, distance, biological, geodetic. Such modules can be configured operate under the IEEE 802.11 wireless local area networks (Wi-Fi) standard, although other wireless standards may be contemplated. The applications for these wireless sensor/actuator may comprise, without limitation, datacenter and building facility, energy conservation, industrial working field monitoring and response, wild fire monitoring and response, facility security monitoring and response, building automation, home automation, video surveillance, agriculture monitoring/responding, hazardous gas leakage monitoring/responding, medical equipment and human health engineering.

Turning now to FIG. 8, where one embodiment of a Wi-Fi sensor module 800 for monitoring environmental conditions is illustrated. In one embodiment, the environmental Wi-Fi sensor module 800 is an intelligent, self contained module that can measure various environmental quantities such as, without limitation: temperature, heat, magnetism, pressure, gas and liquid flow, gas and liquid volume, odor, viscosity and density, humidity, chemical proportion, light, time-of-flight, infrared, proximity, radiation, subatomic particle, hydraulic, acoustic, motion, vibration, orientation, distance, biological, geodetic. In the illustrated embodiment, the Wi-Fi environmental sensor module 800 is configured to sense temperature, humidity, light sensor, and audio and operates under the IEEE 802.11b (Wi-Fi) for wireless communications to the Internet. The environmental Wi-Fi sensor module 800 does not use any wires and can be precisely located where an environmental parameter is to be sensed and measured using any suitable fastener. For example, the environmental Wi-Fi sensor module 800 can be easily held in place by hook and loop fasteners such as those marketed under the name Velcro®, tie-wraps, double-sided adhesive tape, and the like. In various embodiments, the Wi-Fi sensor module 800 can report temperatures with an accuracy of +/−1° C. and can be located up to 100 meters from a common Wi-Fi access point, for example. The environmental Wi-Fi sensor module 800 can be specifically configured to run off batteries and will last generally over two years on one set of batteries. In one embodiment, the environmental Wi-Fi sensor module 800 can be combined with an Internet dashboard application as described hereinabove to continuously monitor sensor data from any IP-Device, at anytime, anywhere on the Internet as a service.

In one embodiment, the environmental Wi-Fi sensor module 800 may be combined with Internet dashboard applications (110, 216, 316, 414, 522 of respective FIGS. 1-5, as discussed hereinabove generally, for example, and as described in one particular embodiment hereinbelow in connection with FIGS. 12-21, for example) for continuously monitoring sensor data from any IP-Device, at anytime, anywhere on the Internet as a service. In one embodiment, the environmental Wi-Fi sensor module 800 can directly connect to a Wi-Fi access point and is compliant with the IEEE 802.11b/g performance and protocol. In one embodiment, the Wi-Fi environmental sensor module 800 can communicate at a data rate of approximately 2-11 Mbps at 2.4 GHZ, industrial, scientific and medical (ISM) unlicensed radio bands. The Internet Protocols include SNMP, ARP, UDP, TCP/IP. Data Security (encryption) includes all IEEE 802.11 security modes available such as WEP, WAP, WPA, WPA2. Sensor control is direct “Over-the-air” adjustable sample rate and other parameters using SNMP and provides automatic discovery and reporting over Wi-Fi. The Wi-Fi environmental sensor module 800 is also able to communicate with cloud-based dashboard management applications.

In one embodiment, the environmental Wi-Fi sensor module 800 comprises a housing 802. In one embodiment, the housing 802 has dimensions of approximately 88.8 mm×36 mm×28 mm (3.5″×1.4″×1.1″). The transmission range is approximately 100-150 meters omni-directional. The housing 802 contains functional circuitry for monitoring environmental conditions as discussed in more detail hereinbelow.

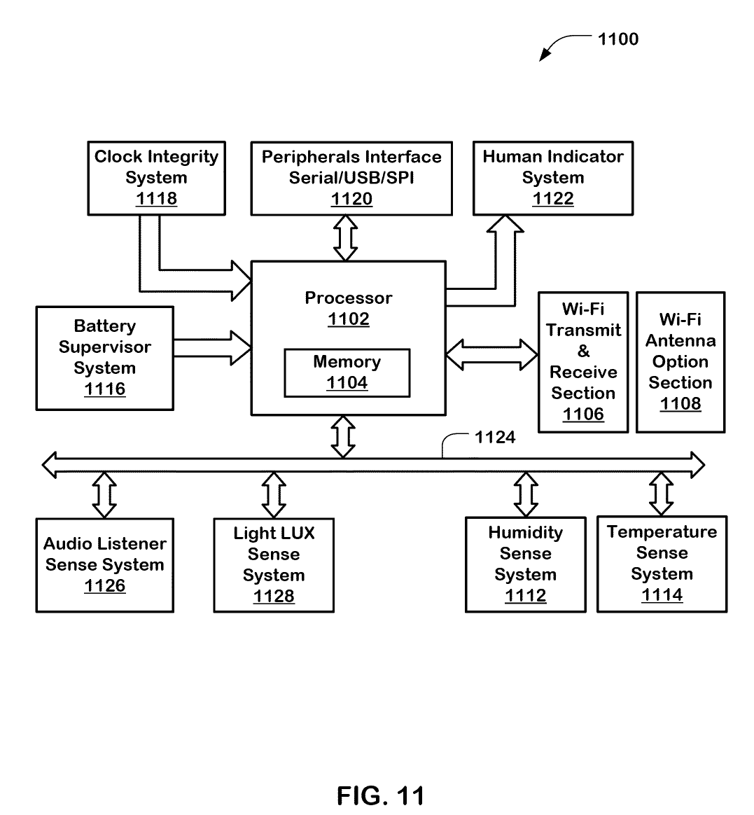

FIG. 11 is a functional block diagram 1100 of an environmental Wi-Fi sensor module. With reference now to FIGS. 8 and 11, in one embodiment, the environmental Wi-Fi sensor module 800 comprises a processor 1102, a memory 1104, and a radio frequency communication system comprising a Wi-Fi transmit/receive section 1106 (transceiver) and a Wi-Fi antenna option section 1108. The environmental Wi-Fi sensor module 800 also comprises an audio listener sense system 1126, a light LUX sense system 1128, a humidity sense system 1112, and a temperature sense system 1114 in communication with the processor 1102 via an internal bus 1124. In one embodiment, the environmental Wi-Fi sensor module 800 also comprises a battery supervisor system 1116, a clock integrity system 1118, a peripheral interface 1120, such as a serial, USB, or SPI, and a human indicator system 1122 all coupled to the processor 1102 and the memory 1104.

It will be appreciated that the functional elements described in connection with FIGS. 9-11 may be described in terms of modules and/or blocks to facilitate description. Such modules and/or blocks may be implemented by one or more hardware components (e.g., processors, Digital Signal Processors (DSPs), Programmable Logic Devices (PLDs), Field Programmable Gate Arrays (FPGA), Application Specific Integrated Circuits (ASICs), circuits, registers, gate logic), software components (e.g., programs, subroutines, logic), and/or combinations thereof. Although certain modules and/or blocks may be described by way of example, it can be appreciated that additional or fewer modules and/or blocks may be used and still fall within the scope of the disclosed embodiments.

Having described the various systems 100, 200, 300, 400, 500 shown in FIGS. 1-5 for monitoring generally subscriber premises and more particularly a datacenter using various types of Wi-Fi enabled sensor modules 600, 700, 720, 740, 750, 800 shown in FIGS. 6-8 deployed throughout the various systems 100, 200, 300, 400, 500 of respective FIGS. 1-5, the specification now turns to a description of a datacenter management console for managing the data generated by the various Wi-Fi enabled sensor modules 600, 700, 720, 740, 750, 800 shown in FIGS. 6-8 deployed throughout the various systems 100, 200, 300, 400, 500. Accordingly, turning now to FIG. 12, where a representative screen shot of an historical data window 1200 associated with a datacenter is displayed by a dashboard application is shown. As described hereinabove in connection with various embodiments, the Wi-Fi enabled sensor modules 600, 700, 720, 740, 750, 800 can be deployed and used anywhere there is an available Wi-Fi environment. These intelligent, self contained Wi-Fi enabled sensor modules 600, 700, 720, 740, 750, 800 may use IEEE 802.11b (Wi-Fi) for wireless communications to the Internet.

Over time, the Wi-Fi enabled sensor modules 600, 700, 720, 740, 750, 800 send an enormous amount of valuable sensed data to the remote Internet server to provide visibility regarding the condition (health or trouble) in any particular area in which they are deployed. Management and presentation of this large amount of information is managed by a computer implemented method (e.g., software application) referred to herein as a dashboard application. Throughout the present specification, the dashboard application may be otherwise referred to, without limitation, as a cloud application process 110 (FIG. 1), Internet application 216 (FIG. 2), cloud based dashboard 316 (FIG. 3), Internet cloud managed service 414 (FIG. 4), dashboard application 522 (FIG. 5). In one aspect, the dashboard application accumulates all the data received from the Wi-Fi enabled sensor modules 600, 700, 720, 740, 750, 800 and displays this data intuitively to allow managers to make detailed analyses of particular sensor data and take any necessary corrective action based on the data. The Wi-Fi enabled sensor modules 600, 700, 720, 740, 750, 800 can be combined with the Internet dashboard application to continuously monitor the data transmitted by the Wi-Fi enabled sensor modules 600, 700, 720, 740, 750, 800 from any IP enabled device, at anytime, anywhere on the Internet as a service.

In one embodiment, the dashboard application provides a managed display of all sensed readings received from the Wi-Fi enabled sensor modules 600, 700, 720, 740, 750, 800 (FIGS. 6-8) deployed in any one of the illustrative systems 100, 200, 300, 400, 400, 500 (FIGS. 1-5). Once the data from the Wi-Fi enabled sensor modules 600, 700, 720, 740, 750, 800 are received by the dashboard application, the data may be displayed on a display that supports joint photographic experts group/graphic interchange format (JPEG/GIF) for true visual of facility and each sensor's location and network parameters, for example. The data transmitted by each of the Wi-Fi enabled sensor modules 600, 700, 720, 740, 750, 800 is displayed in real-time and can be analyzed over a predetermined period of time such as minute(s), hour(s), day(s), week(s), month(s), quarter(s), year(s), for example, without limitation. Hierarchical authorization levels for different users may be provided to view certain levels of sensor data. Through a GUI, the user may determine and set various settable parameters including, without limitation, hot/cold threshold, battery life, AC current, voltage, power limits, among other parameters, for example. In one aspect, the dashboard application provides auto-discovery of all Wi-Fi enabled sensor modules 600, 700, 720, 740, 750, 800 deployed in any one of the systems 100, 200, 300, 400, 500, for example. The dashboard application also provides a platform for managing the individual configuration of any of the Wi-Fi enabled sensor modules 600, 700, 720, 740, 750, 800. In various embodiments, the dashboard application also provides a set of assessment tools to assist in data analysis, cloud-based, fully redundant and backup of all data, support of various industry application program interfaces (APIs) to exchange sensor data, and support for International languages including English, Japanese, Korean, and Chinese.

In one embodiment, the dashboard application operates in conjunction with the bridge server 210 (FIG. 2) and configured W-Fi access point 208 (FIG. 2). In various embodiments, the dashboard application may be configured to analyze data relating to the environment such as a Set-Point Optimal Temperature, what may be referred within this specification as the SPOT-ON™ energy efficiency level, AC power monitoring, surveillance monitoring, critical and early warning system monitoring, commissioning by the Leadership in Energy and Environmental Design (LEED), an internationally recognized green building certification system, thermal assessment, baseline assessment, and AC power assessment. The dashboard application will now be described in connection with a series of GUI windows hereinbelow.

With reference still to FIG. 12, the screen shot of Historical Data window 1200 illustrates one example of a datacenter management console GUI that displays the temperature 1202 received from Wi-Fi enabled sensor modules 600, 700, 720, 740, 750, 800 (FIGS. 6-8) deployed in any one of the systems 100, 200, 300, 400, 500 (FIGS. 1-5), for example. Temperature is shown along the vertical axis and a one week period 1204 is shown along the horizontal axis. As depicted in the window 1200, over the week period, the maximum temperature 1206 is displayed along with the average temperature 1208, the minimum temperature 1210, and the threshold setting 1212. Although the example screenshot displays temperature data associated with the measurements received from the Wi-Fi enabled sensors, any measured parameter such as, for example, without limitation: temperature, heat, electrical resistance, electrical current, electrical voltage, electrical power, magnetism, pressure gas and liquid flow, gas and liquid, odor, viscosity and density, humidity, chemical proportion, light time-of-flight, light, image, infra-red, proximity, radiation, subatomic particle, hydraulic, acoustic, sound, motion, vibration, orientation, distance, biological, and/or geodetic measurements may be measured, transmitted, received, analyzed, and displayed in a similar manner by the dashboard application.

In one embodiment, the dashboard application may be considered a cloud based tool for monitoring the Wi-Fi enabled sensor modules 600, 700, 720, 740, 750, 800 (FIGS. 6-8) and analyzing the data recorded and transmitted by such modules. Because enormous amounts of data are streamed into the dashboard server from the datacenter in real time, the dashboard application enables analysis and management of the data in a user intuitive manner. Accordingly, the dashboard application assists the user present this data in a meaningful format and can help reduce cooling costs, CO₂ emissions, and energy consumption costs associated with a datacenter generally. A plurality of tools is encompassed with the dashboard application to assist the users to monitor and analyze datacenter operations. User specific configurations and settings can be personalized to meet specific needs.

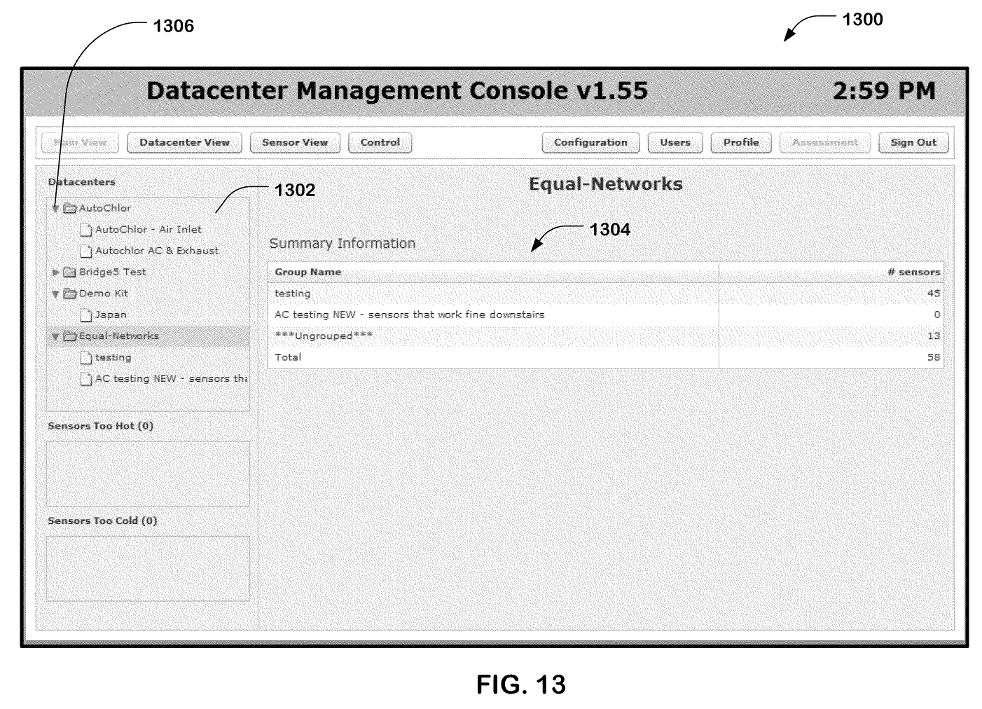

FIG. 13 illustrates a screen shot of a Main window 1300 displayed by the dashboard application. The Main window 1300 describes the overall performance of all the Wi-Fi enabled sensor modules 600, 700, 720, 740, 750, 800 (FIGS. 6-8) deployed in any one of the systems 100, 200, 300, 400, 500 (FIGS. 1-5). The main window 1300 provides a quick view to determine if the facility is operating optimally within user specified ranges, such as user specified temperature ranges, for example.

At the top left corner of the Main window 1300, a datacenter list 1302 of all available datacenters and subgroups depending on access permissions is displayed. Upon clicking a particular datacenter, summary information 1304 associated with the selected datacenter will be displayed. The summary information 1304 provides general information about the subgroups that belong to it and how many sensors belong to each group. Subgroups in the datacenter list 1304 can be collapsed or expanded by clicking on the triangle 1306 to the left of the datacenter name. Clicking on the subgroup will provide information such as the Min/Max/Avg and table charts.

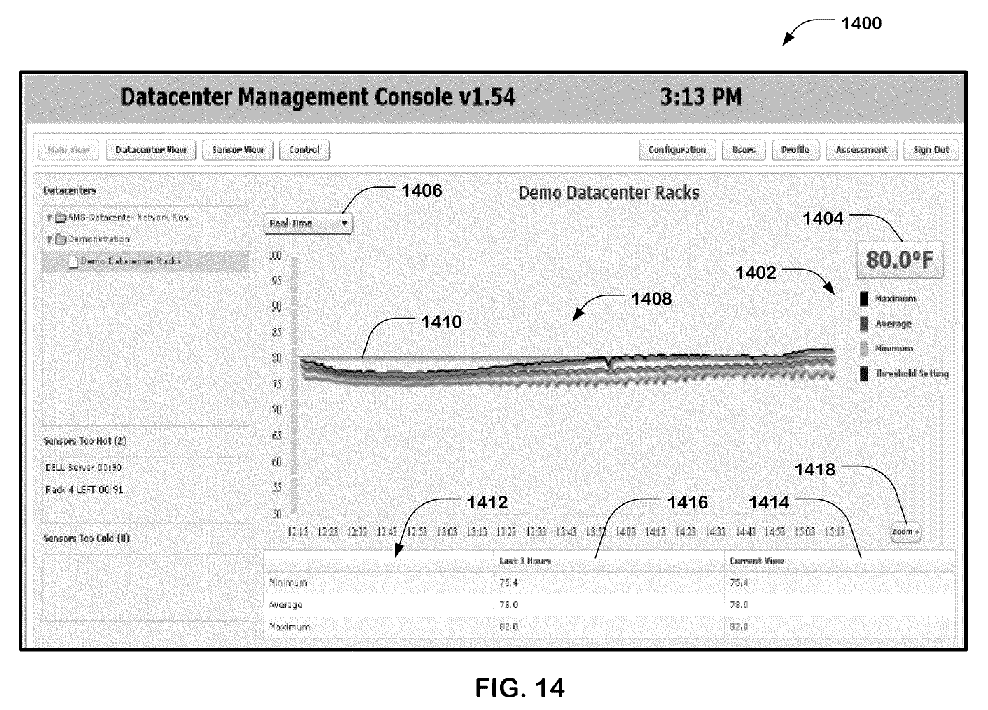

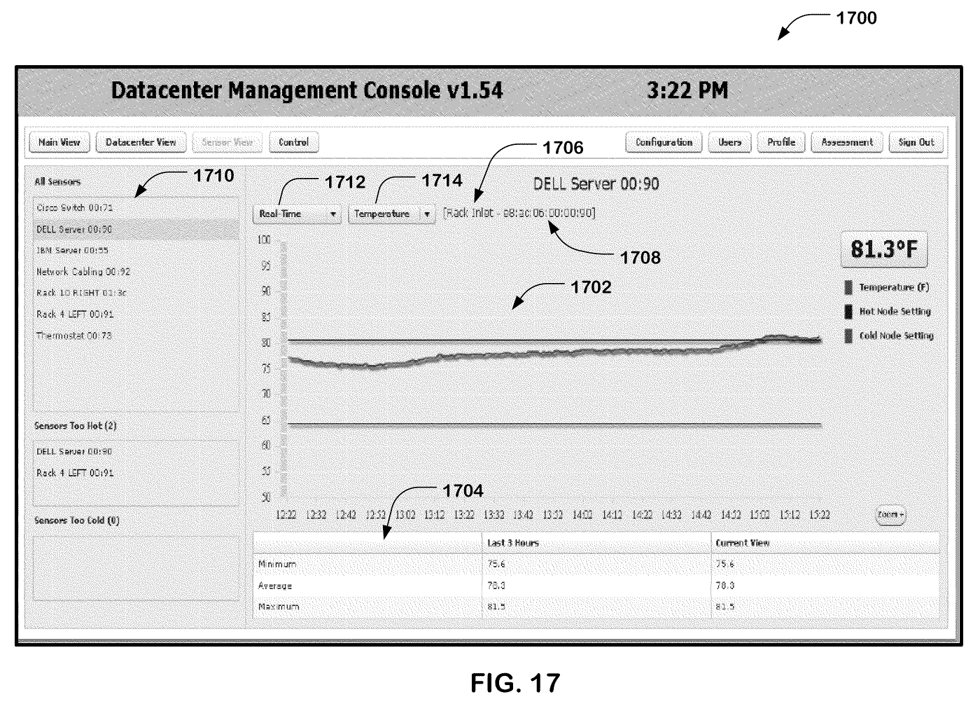

FIG. 14 illustrates a screen shot of a Minimum/Maximum/Average Chart window 1400 displayed by the dashboard application. Clicking on each subgroup will reveal collective information about all the sensors within that group. A basic Min/Max/Avg chart 1408 displays the real-time Min/Max/Avg temperatures by the minute for a period of the previous three hour window and a threshold setting 1410. This data is updated every minute as new data comes in. Here the mouse can be moved over any data point to find its temperature and time. On the top right portion of the chart, a legend 1402 is provided to define the lines on the chart as well as a temperature reading 1404. The temperature displayed here is the last reported average temperature. The color of the temperature will be red if it is above the hot threshold, blue if it is below the cold threshold (when applicable), and green otherwise, indicating that it is operating within the hot/cold thresholds. In the Main window 1330 (FIG. 13), there is currently only a “Hot” threshold for each group. In the Sensor window (1700 in FIG. 17 hereinbelow) a “Cold” threshold can also be applied.

Historical data can be displayed by selecting a drop down selector 1406 located above the temperature axis. The historical data provides a view of the data over a longer time frame. By using this feature, historical data over predetermined period can be viewed. In one aspect, historical data up to three years can be viewed, for example. In one aspect, historical data older than three hours may be broken down into buckets of time that can be in hours or even days depending on the time frame to help consolidate the vast amounts of data. The stamped time represents the beginning time of when the bucket starts. For example, a 4 hour bucket stamped at 12:00 pm will contain data from 12:00 pm to 4 pm.

The table 1412 located below the Min/Max/Avg chart 1408 displays the same data in table format. Under the “Current View” column 1414, the Min/Max/Avg data for the currently viewed timeframe is displayed. This will be equivalent to the last three hours if the real-time view is selected or one week if the one week view is selected. The middle column 1416 will generally display the values from the last three hours. This is the quickest way to compare how a particular datacenter is running currently to how it ran over the last week or month or year.

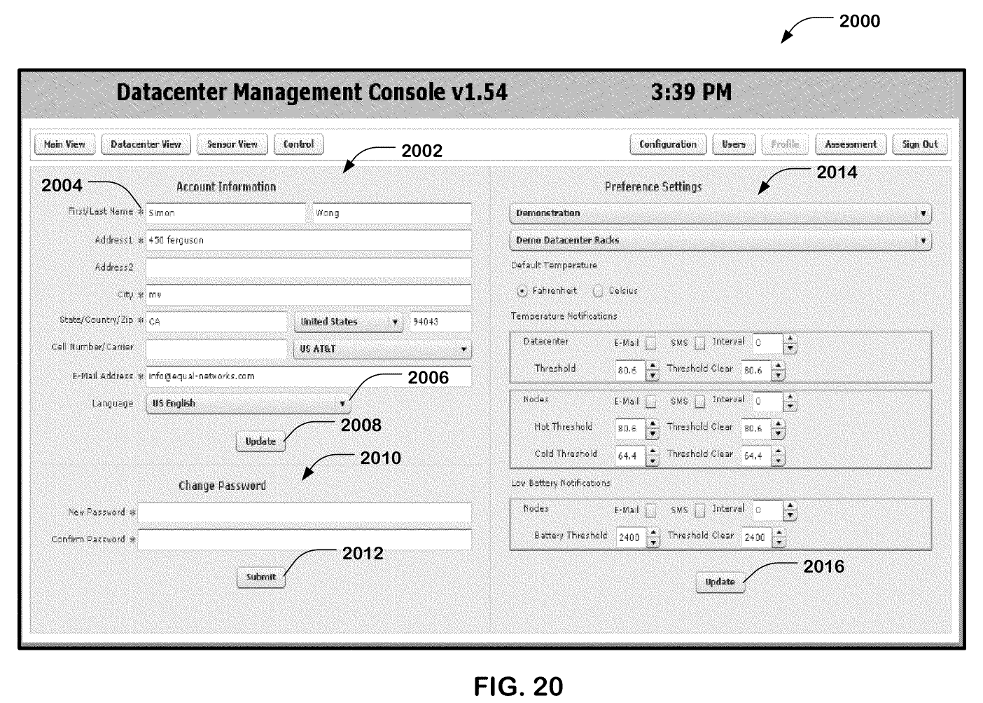

A too Hot/Cold lists contain sensors that are reporting above or below set temperatures. The set temperatures threshold setting 1410 are set by individual users. The temperature threshold setting 1410 may be modified in the Profile window (2000 in FIG. 20 hereinbelow). Clicking on a sensor on these lists will display that sensor's Sensor window (1700 in FIG. 17 hereinbelow).

At the bottom right of the Min/Max/Avg chart 1408 a zoom button 1418 is provided to change the maximum and minimum temperatures shown on the graph to provide the user with more detail. A zoom button also is provided for the Sensor window (1700 in FIG. 17 hereinbelow).

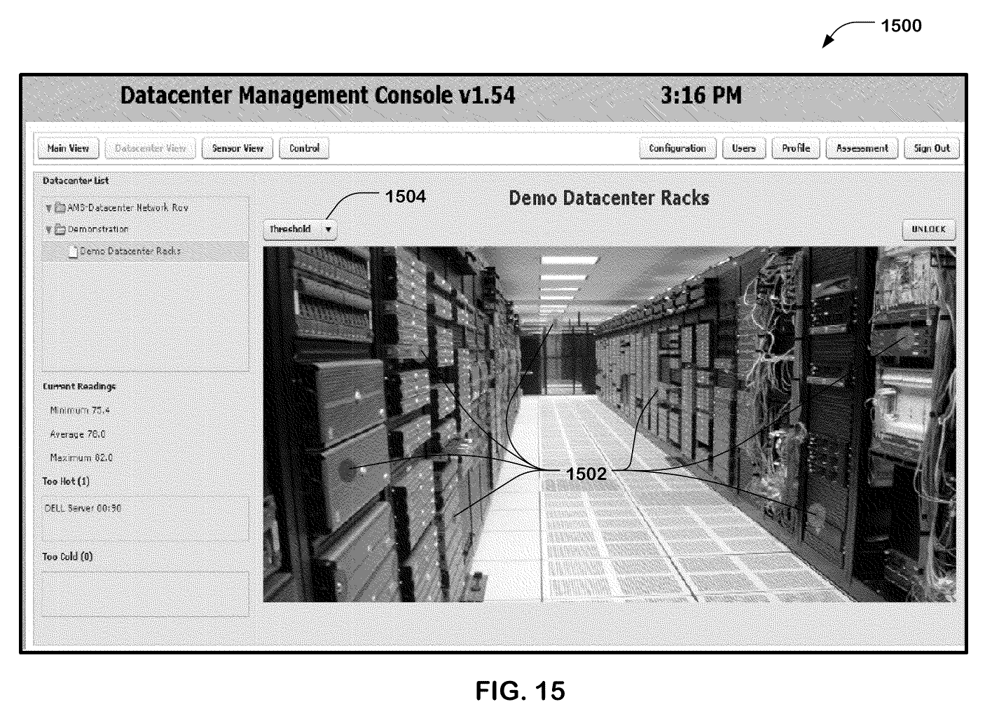

FIG. 15 is a screen shot of a Datacenter Window 1500 displayed by the dashboard application. The Datacenter Window 1500 displays a graphical representation of the actual location of each sensor 1502 in the datacenter facility and the temperature status, among other parameters discussed hereinabove, of each individual sensor in a subgroup. In one aspect, the available modes in the datacenter view 1500 are the THRESHOLD and HEAT MAP views. In other aspects, other modes may be made available depending on the parameter being measured by the sensors. The drop down selector 1504 enables toggling between these two modes. The data seen in the datacenter view may be updated on a predetermined period such as every minute, for example, to ensure an accurate representation of a particular datacenter. Just like the sensors that show up in the Too Hot/Cold lists discussed hereinabove, by clicking the sensor in the picture the user will be taken to the individual sensor's Sensor window (1700 in FIG. 17 hereinbelow).

In threshold mode, shown in FIG. 15, the color of a sensor can be one of the following: White for no data, Red for too hot, Green for within set thresholds, and Blue for too cold. The color of the sensor allows the user to get a quick idea of the locations of sensors violating temperature thresholds. The thresholds that determine these colors are set in the Profiles section (see hereinbelow).

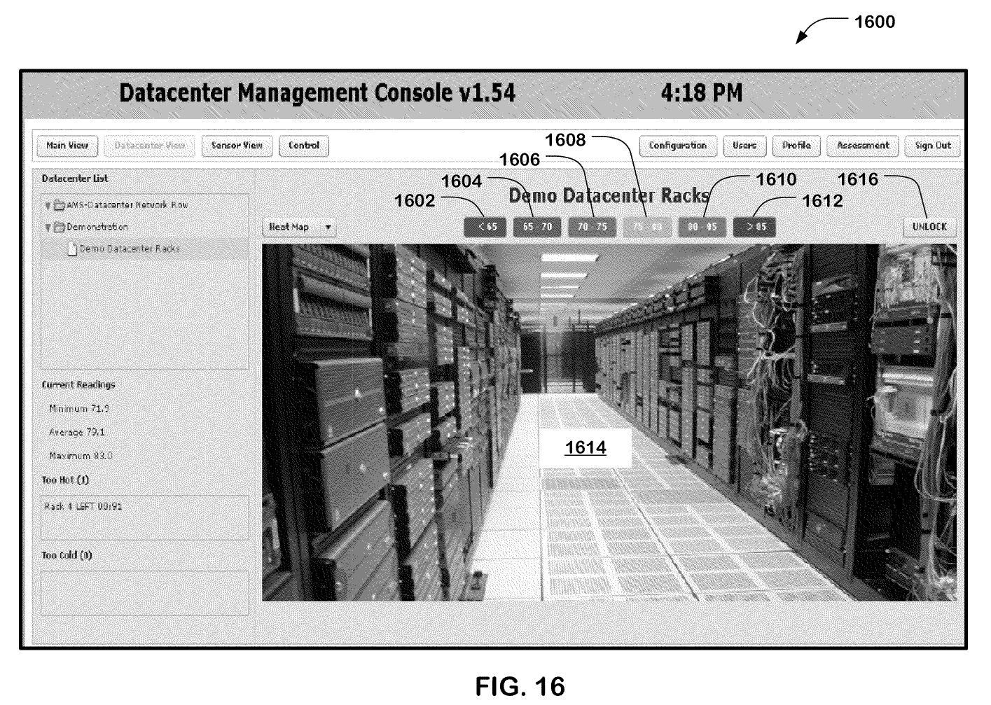

FIG. 16 is a screen shot of a Datacenter Heat Map window 1600 displayed by the dashboard application. In heat map mode, the color of a sensor is dependent on which temperature range the current reading from the sensor lies in. The color coding and their corresponding temperature ranges are:

Purple 1602: <18° C. (<65° F.).

Blue 1604: 18-21° C. (65-70° F.).

Green 1606: 21-24° C. (70-75° F.).

Yellow 1608: 24-27° C. (75-80° F.).

Orange 1610: 27-30° C. (80-85° F.).

Red 1612: >30° C. (>85° F.).

These temperature color ranges can be seen on top of the layout picture (1602, 1604, 1606, 1608, 1610, 1612). Since all sensors should be operating within set threshold ranges, all sensors should be green in the threshold mode. This, however, provides the user with very little information. With different colors representing different temperature ranges, the heat map mode can give a better depiction of the hot and cold spots in the datacenter facility being monitored.

The administrator can place or move a sensor on the image of the datacenter view 1614 to accurately depict its location in reality. To move a sensor, the user can simply the UNLOCK/LOCK button 1616 on the top right hand corner of the window. Once unlocked, the user can use the mouse to drag and drop a sensor in the location desired. A finger shows when sensor is selected and then holding down the left mouse button while moving the mouse to a desired location moves the sensor. Once the sensor is located in the desired position, the mouse button may be released and the process repeated for each sensor and pressing the LOCK button when finished.

FIG. 17 is a screen shot of a Sensor window 1700 displayed by the dashboard application. The Sensor window 1700 provides detailed performance information of an individual sensor. A Min/Max/Avg chart 1702 and a table 1704 are provided just as in the Main window 1400 (FIG. 14) but contain data from a single sensor rather than a group or network of sensors. All functionality of the Min/Max/Average chart 1702, table 1704, and too Hot/Cold lists remain the same. In addition to performance data, the sensor name 1706 and media access control (MAC) address 1708 will be displayed just above the Min/Max/Avg chart 1702. The sensor threshold settings are set in the Profile window (2000 in FIG. 20 hereinbelow).

An all sensors list 1710 is provided on the top left of the Sensor window 1700 screen displays all of the sensors belonging to the selected subgroup in the Main window 1440 (FIG. 14) screen. Each sensor is listed according to its name and can be viewed individually by using the up/down keys or by clicking on the sensor of interest. If a datacenter is selected instead of a group in the Main window 1400, the sensors list 1710 in the Sensor window 1700 will contain all of the available sensors in that datacenter including those that are ungrouped.

Battery life can be monitored by a predetermined class of users. For example, users with the service provider or super user profiles (see FIG. 20 hereinbelow) can monitor battery levels for each sensor. To the right of the Real-Time/Historical drop down menu 1712, another drop down menu 1714 is located that allows the user to change from temperature readings to millivolts (mV) readings. When millivolts (mV) is selected, the battery levels are shown in mV readings and are displayed on the Min/Max/Avg chart 1702.

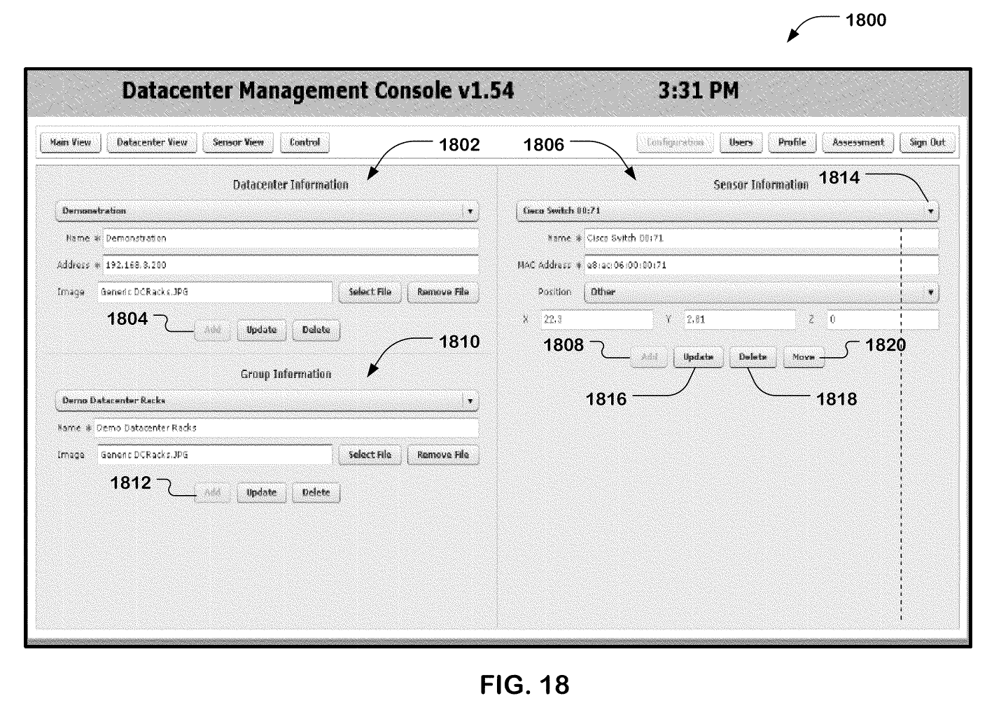

FIG. 18 is a screen shot of a Configuration Panel window 1800 displayed by the dashboard application. The Configuration Panel window 1800 is the main administrative window for the dashboard application. Here an administrator can create new datacenters and groups using the pull down menus. Sensors can be entered into groups manually and can be moved around. The name of a sensor can also be changed from within the Configuration Panel window 1800.

Datacenters and groups can be created manually in the datacenter information section 1802. The name (which can be at least 6 characters long in one aspect) and IP address for the datacenter to be added is entered in the appropriate text box (or data entry field). One the appropriate text has been entered in the text box, the new datacenter is added when the add button 1804 is clicked. In addition, the user can click on the update or delete buttons to execute those features. An image file to be shown on the datacenter view 1500 (FIG. 15) when the datacenter itself is selected also may be entered. If no image is selected, a default image will be put in its place. If the Wi-Fi bridge server 210 (FIG. 2) includes an auto-discovery feature, sensors are automatically detected and placed into a datacenter. Accordingly, a new datacenter setup should only require creating new groups, renaming, and moving sensors. A sensor information section 1806 is provided for the user to enter the sensor name, MAC address, position, among other information. The information can be entered by selecting the add button 1808.

Groups may be created by entering information in a “Group Information” section 1810. To create a group, a user first selects a datacenter in the “Datacenter Information” section 1802 which is to be part of the new group. A name (which can be at least 6 characters long in one aspect) is entered in the appropriate text box for the group and if desired, an image also may be entered. The image may be used as a background image representing the location of the sensors in the group. Once the name has been entered, clicking the “Add” button 1812 creates the new group. Meaningful names such as “Hot Aisle,” “Cold Aisle,” “Expensive Servers,” “Rack 02 Top” or “Air-conditioning Ducts” groups, can help users analyze data from equipment and racks more intuitively, for example.

In addition, the user can click on the “Update” or “Delete” buttons to update or delete fields in the “Datacenter Information” 1802, “sensor Information” 1806, and/or “Group Information” 1810 sections. To change the name of a sensor, the datacenter and group to which the sensor belongs to is selected. Once selected, under the “Sensor Information” section 1806, the pull down the menu 1814 is selected until the desired sensor to be renamed is found. The name is entered and the “Update” button 1816 is selected. To delete a sensor and all its corresponding data, the sensor is selected from the pull down menu and the “Delete” button 1818 is selected. Under the “Sensor Information” section 1806, there is a move button 1820. Selecting the “Move” button 1820 will open a new window descried hereinbelow in connection with FIG. 18.

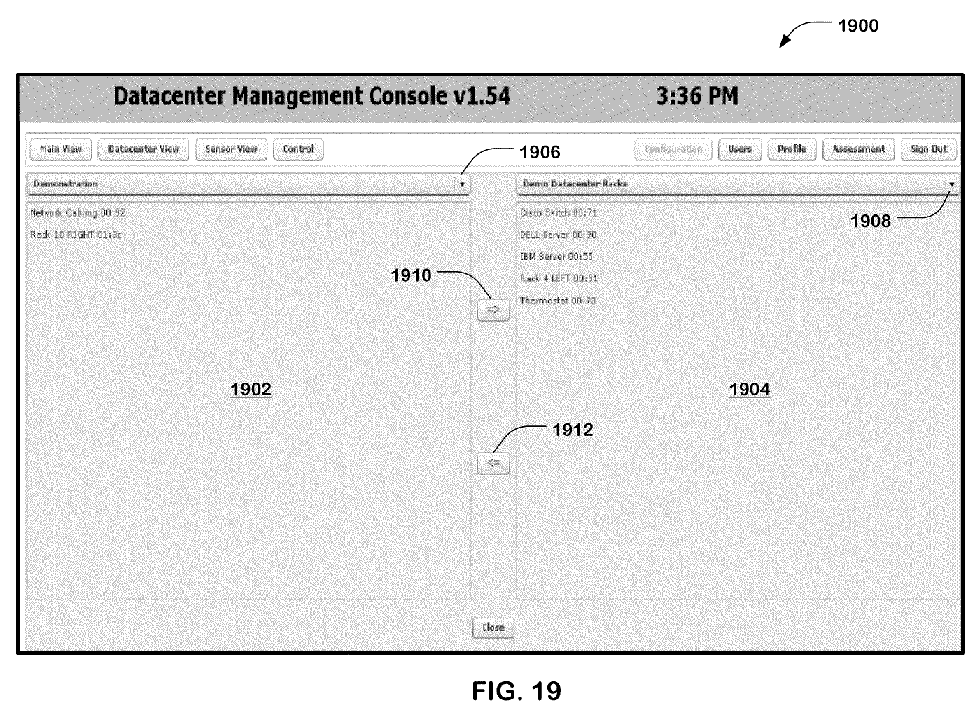

FIG. 19 is a screen shot of a Sensor Move window 1900 displayed by the dashboard application. Within the Sensor Move window 1900, multiple sensors can be moved from group to group quickly while retaining all the data it has collected in the past. In the sensor move view window 1900 there are two window columns. The left window 1902 has a pull down menu 1906 to select the datacenter in which to move the sensors. All of the sensors that are shown under this column are ungrouped. On the right window 1904 there is also a pull down menu 1908 for all the groups that belong to that datacenter. Simply selecting all the sensors to be moved in one column and then using the arrow buttons “=> symbol” 1910 and “<= symbol” 1912 between the two columns to make the move. To move sensors from one group to another group, the sensors should be ungrouped before moving them to the new group. For example, select a sensor or a few sensors on the left window 1902 and then select the => symbol 1910. All selected sensors will be moved to the right window 1904 group that has been selected from the pull down group choices. Selecting a sensor on the right window 1904, and then selecting the <= symbol 1912, will move that sensor out of the group.

FIG. 20 is a screen shot of a Profile window 2000 displayed by the dashboard application. The Profile window 2000 contains all Account Information 2002 such as the password, contact information, and user preference settings for temperature units and thresholds. Account Information New Users must fill out the information with a red asterix 2004 next to the box. These are the Name, Address, City, State, ZIP Code, and email address boxes. The email address will be used to notify the user of any alerts that may occur if the e-mail notifications are turned on (see preference settings below). The Language drop down 2006 allows the dashboard to be displayed in other languages. Currently supported languages are English, Japanese, Korean, and Chinese. The cell number and the carrier information are used to send out SMS notifications. When desired changes have been completed, press the “Update” button 2008 and then “OK” on the confirmation popup box.

To change to a new password, a new password is entered and confirmed in the corresponding boxes in the Change Password section 2010. When complete, the “Submit” button 2012 and “OK” are pressed on the confirmation popup box.

The Preference Settings section 2014 are where the units for temperature and the threshold temperatures can be changed. To change the default units for temperature, the datacenter and or group may be selected. The units of measure are then selected and the “Update” button 2016 on the bottom is clicked. Because datacenters or groups of sensors maybe located in various parts of the world, temperature unit settings are set for each datacenter and for each group. This means that one datacenter with many groups can have a group of sensors set to report in Celsius and another group in Fahrenheit even though they belong to the same datacenter.

Threshold alert settings below the temperature units settings are the threshold settings. Custom thresholds can be set by each user account for the same datacenter. When a threshold set by the user is breeched, the user can choose to be notified via e-mail or SMS. To enable this feature, make sure the boxes “E-mail” and/or “SMS” are checked. There is also an interval box next to each threshold that is set. The interval (minutes) is the period between each repeat notification once a threshold has been breached. An interval of 5 will send repeat notification alerts every 5 minutes until the threshold clear is crossed turning off the alert. By default the interval is set at 0 which will send an alert immediately every time a new data packet is received. This rate can vary depending on packet rate. There are two types of thresholds that can be set to trigger alerts: Group thresholds, which sets a threshold that is triggered only when the average temperature of the group of nodes crosses the set threshold temperature; and node thresholds, which sets a threshold that applies to each individual sensor within a group that is triggered when just one node triggers the alert. To set a group threshold or group node threshold, select from the pull downs the datacenter and then group to which you wish to apply the thresholds to. The corresponding threshold parameters can then be filled in and the “Update” button 2016 clicked. In one aspect, the threshold clear temperatures are temperatures that the system needs to cross in order to clear the alerted state and stop all future notifications if an interval of greater than 0 is set. For example, for node cold threshold, if the threshold is set at 60 F and the clear threshold is set at 65 F, the node must fall below 60 F to trigger the alert and then rise above 65 F to clear the alert. The same procedure applies to the low battery notifications except the values will be mV instead of Celsius or Fahrenheit.

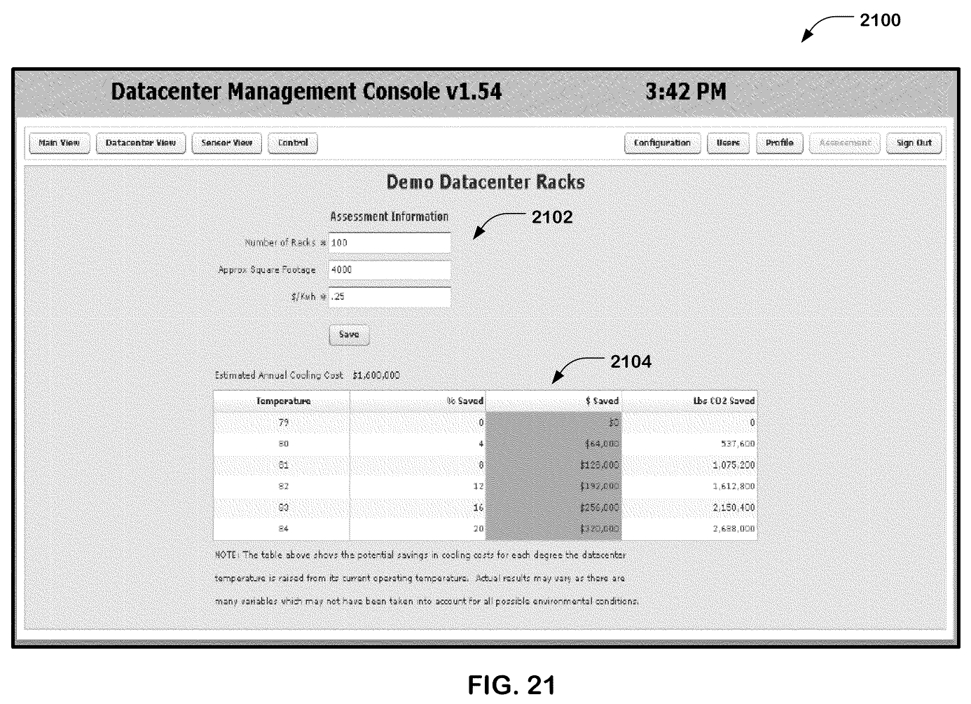

FIG. 21 is a screen shot of an Assessment Tool window 2100 displayed by the dashboard application. The Assessment Tool window 2100 is a what-if savings calculator for the selected datacenter. The number of racks in the datacenter along with the cost of electricity per kWh is entered in the assessment information section 2101. A TCO (total cost of ownership) Calculator will then approximate the square footage of your datacenter and use the current average operating temperature for the selected group to estimate how much money you are currently spending in a year at the current temperatures. In a table 2104 below, estimates for percentage of total cooling costs saved, total dollar amount saved, and total lbs. of CO₂ saved are shown. With this chart the user can see how much money can be saved and how much CO₂ can potentially be reduced per year by raising the operating temperatures a few degrees. The TCO calculator provides assistance with future planning and is accurate for typical datacenters. In one aspect, the TCO calculator assumes that 75%-85% of the racks are occupied with IT equipment and consume 200 W-500 W per 1 RU on average, in a 42 RU rack.

Having described the various windows and screen shots associated with the dashboard application, the description now turns to one embodiment of a computer implemented method enabled by the Wi-Fi sensor module systems 100, 200, 300, 400, 500 (FIGS. 1-5) for controlling and adjusting the datacenter Set-Point Optimal Temperature, what may be referred to as the SPOT-ON™ energy efficiency level. In one embodiment, the computer implemented control method provides datacenter managers complete visibility to every equipment rack inlet temperature by placing uniquely configured Wi-Fi sensor modules 600, 700, 720, 740, 750, 800 (FIGS. 6-8), specifically for datacenter use, on the front of every computer rack in the datacenter. Combined with using the intuitive dashboard computer implemented method, datacenter managers are provided instant visibility and confidence of exactly where their safe regions are and where their trouble areas are, and can adjust the datacenter for energy efficiency. In various other embodiments, the computer implemented method may provide visibility to every equipment rack inlet parameter, such as, without, limitation: heat, electrical resistance, electrical current, electrical voltage, electrical power, magnetism, pressure, gas and liquid flow, gas and liquid volume, odor, viscosity and density, humidity, chemical proportion, light time-of-flight, light radiation, image, infra-red, proximity, radiation, subatomic particle, hydraulic, acoustic, sound, motion, vibration, orientation, distance, biological, or geodetic measurements may be received, analyzed, and displayed in a similar manner by the computer implemented dashboard method and/or the computer implemented control method.

Accordingly, although the computer implemented control method will now be described in terms of temperature control, it will be appreciated that the computer implemented control method may be adapted and configured for controlling other paramters, without limitation: heat, electrical resistance, electrical current, electrical voltage, electrical power, magnetism, pressure, gas and liquid flow, gas and liquid volume, odor, viscosity and density, humidity, chemical proportion, light time-of-flight, light radiation, image, infra-red, proximity, radiation, subatomic particle, hydraulic, acoustic, sound, motion, vibration, orientation, distance, biological, or geodetic measurements received by the computer. The computer implemented method provides the capability to set the datacenter's optimal set-point for that particular set of computer equipment matched to the cooling equipment. Accordingly, the datacenter manager can optimally adjust his datacenter room's cooling set-point level to suit his comfort level of air delivery to his equipment. This means the equipment inlet air is “customized” to the datacenter manager's wishes and to his heating ventilation and air conditioning (HVAC) equipment.

The computer implemented control method works in conjunction with the Wi-Fi sensor modules Wi-Fi sensor modules 600, 700, 720, 740, 750, 800 (FIGS. 6-8) deployed in the Wi-Fi sensor module systems 100, 200, 300, 400, 500 (FIGS. 1-5) as discussed hereinabove. In one aspect, the Wi-Fi sensor modules are sensor/actuator platforms consisting of one or more, processor system each consisting of a memory, an IEEE802.11-based radio frequency communications system, and a battery power system, as discussed in detail hereinabove. The sensors do not rely on cables, wires, or other harnesses for supplying data or power. There are no exterior connections to these devices other than through a wireless RF communications.

The process begins by placing Wi-Fi sensor modules in the front of at least one computer rack in the datacenter, and more preferably in front of all the computer racks in the datacenter. Accordingly, if the latter option is selected, a computer rack cannot be skipped and 100% or substantially all of the computer racks will be provided with the sensors. In one aspect, the Wi-Fi sensor modules are used to report on every computer rack air inlet temperature, whereas in other aspects the Wi-Fi sensor modules may be used to report on other parameters associated with every computer rack. The manager can adjust the temperature settings of the air-conditioning system to ensure change occurs slowly. Substantially every rack is to be instrumented to avoid any uncertainty about unanticipated hot spots endangering any of the equipment.

The manager then configures a profile on the dashboard computer implemented method discussed hereinabove specifying the threshold level to monitor for each rack, selecting a threshold temperature that he is confident up to which all his equipment will operate perfectly. The threshold set is the preferred temperature for the air inlet temperature to the existing equipment and generally does not need to adhere to any industry recommendation, such as from ASHRAE or NEBS. Once the threshold profile is set via the dashboard computer implemented method, the manager starts to adjust the room temperature by manually (or automatically) moving the thermostat or controls of the HVAC upwards, typically one degree at a time. After every degree moved, the manager waits for the room to settle to the new setting and uses the dashboard computer implemented method to ensure that all rack inlet temperatures are still operating below the new threshold. The manager repeats this process, one degree at a time, until one or more air inlet temperatures reaches the threshold, as shown on the dashboard computer implemented method and via email or via SMS alert. At this point the manager may stop this process: the SPOT-ON™ efficiency setting has been reached. The datacenter's set-point temperature has now been adjusted to the optimal setting for his particular set of equipment and matched with the room's cooling equipment capabilities. The benefit of this system is that the threshold level is one with which the manager feels most comfortable for the particular datacenter and knows that none of the equipment has been placed in harm's way. The uptime is maintained while the cooling efficiency is maximized. The process works for old inefficient datacenters as well as for most contemporary datacenters, because the set-point can be adjusted for the particular set of equipment, the particular HVAC system, and the particular threshold the manager has set. No new cooling equipment is introduced in this process.

For every degree of temperature that the HVAC equipment can be moved upwards, the datacenter saves 4% of the total cooling expenditures. For a typical datacenter, this could mean over $300,000 in a year. The Wi-Fi sensor module systems 100, 200, 300, 400, 500 (FIGS. 1-5) described herein gives provide SPOT-ON technology which reduces the datacenter's fixed operating expenses while lowering the corporate carbon footprint.

In other implementations, the datacenter manager can use this newly gained information to direct localized cures to certain hot areas. The manager now has granular visibility of the datacenter equipment's actual heat exposure in real-time, a capability which was previously unavailable. Using this new “eye” (e.g., the computer implemented control method and/or dashboard) the manager can confidently make positive adjustments to the datacenter equipment. Changing equipment placement, shuffling around equipment, adding new equipment, and re-allocating unused resources can all now be performed with both visibility and confidence. Without the visibility provided by the computer implemented control method the datacenter manager would have never considered any change. One example of the system's use is to confirm, with actual measurements, a datacenter's Computational Fluid Dynamics (CFD) model. Another example is to direct a Wi-Fi sensor module specifically at the most important or expensive equipment to ensure it is well protected.

The Wi-Fi sensor modules 600, 700, 720, 740, 750, 800 (FIGS. 6-8) discussed hereinabove may be located wherever temperatures or other measurements are required. The Wi-Fi sensor module systems 100, 200, 300, 400, 500 discussed hereinabove are configured to monitor and display the status of each of the Wi-Fi sensor modules 600, 700, 720, 740, 750, 800 on the computer implemented dashboard, from any Internet connection. Control of HVAC/CRAC through BACnet enabled protocol control is also provided. Those skilled in the art will appreciate that BAcnet is a data communication protocol for Building Automation and Control Networks developed under the auspices of the ASHRAE.

In one embodiment, the temperature for rack inlet ranges may be set by the datacenter administrator and each sensor rack inlet will be monitored 24-hours per day, seven days per week, to thresholds and the policing criterion set by the datacenter management. Any violations can produce a response by issuing alerts to cell phone/SMS/Laptop, and triggering an escalation process.

In another embodiment, the Wi-Fi sensor modules 600, 700, 720, 740, 750, 800 (FIGS. 6-8) can be placed at the air inlet and air outlet of every server in order to measure the temperature difference between the incoming air and the outgoing air. Thus, the heat generated by each server is monitored. The advantage in measuring every server is that the cooling cost can be allocated to each server proportionally to the amount of heat generated by that server. Thus, for servers generating heat in excess of certain predefined threshold, they will bear a higher cost in cooling the zone. This calculation allows the datacenters to recoup cooling cost from servers generating excessive heat (over the predefined threshold). In yet another embodiment, sensors are placed at strategic locations with respect to a rack in order to measure the temperature of the air generally at the inlet of the servers of the rack and the temperature at the air outlet of the servers of the rack, thus allowing the measurement of the increase in temperature generated by the respective rack of servers. Billing of the amount of excessive heat generated by the rack (on a rack basis) can be produced and billed accordingly in order for the datacenter to recoup the cooling cost.

In summary, the computer implemented control and/or dashboard systems and methods provide, generally, matching of IT load inlets and equipment cooling to the best efficiency, full visibility of substantially or every equipment rack's air inlet temperature. The systems and methods also de-emphasize “hot spots.” As long as the hot-spots do not affect inlet levels, they are non-detrimental to the equipment. The systems and methods also provide completely wireless communications from sensor to access point using ubiquitous Wi-Fi access points. Manager selected air inlet temperature to the equipment, dashboard alerts to cell phone or SMS when critical thresholds are crossed, leverage of existing Wi-Fi and no back-end software integration are also additional advantages provided by the systems and methods. Finally, the Wi-Fi sensor modules 600, 700, 720, 740, 750, 800 (FIGS. 6-8) can operate last for years without battery change or maintenance.

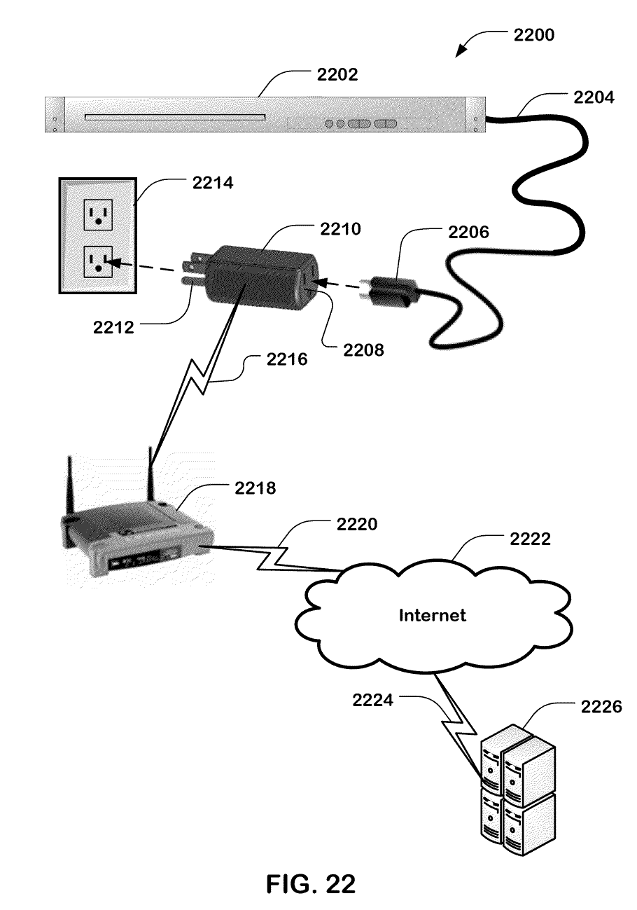

FIG. 22 illustrates one embodiment of a system 2200 for monitoring the AC power load among other quantities of a server 2202 located at a subscriber premise (e.g., a datacenter). In one embodiment, the server 2202 is electrically connected to an AC power meter Wi-Fi sensor module 2210 through an electrical chord 2204. A plug portion 2206 of the electrical chord 2204 is plugged into the receptacle portion 2208 of the AC power meter Wi-Fi sensor module 2210. The plug 2212 portion of the AC power meter Wi-Fi sensor module 2210 is plugged into an AC power outlet 2214. In operation, the AC power meter Wi-Fi sensor module 2210 measures the AC power, among other quantities, consumed by the server 2202 and communicates the measured information over a wireless link 2216 to a Wi-Fi access point 2218. The Wi-Fi access point 2218 communicates the measured information over a wide area network such as the Internet 2222 over a wired or wireless link 2220 to a remote server 2226. The remote server 2226 receives the measured information and stores in a database. The server 2226 also includes a dashboard software application for managing, analyzing, and displaying the measured information received from the AC power meter Wi-Fi sensor module 2210. It will be appreciated that the server 2226 may comprise one or more application server(s), communication server(s), database server(s) and the like. In one aspect, a user can send control commands from the server to the AC power meter Wi-Fi sensor module 2210 for purposes of controlling the operation of some aspects of the server 2202. Although not shown, in one embodiment a Wi-Fi bridge server may be employed in the wireless network that operates in conjunction with the AC power meter Wi-Fi sensor module 2210 deployed in the available Wi-Fi wireless environment. In one aspect, the bridge server may be configured to perform traffic cop type services to control the data communications flowing from the AC power meter Wi-Fi sensor module 2210 to the Internet 2222 and the remote server 2226.

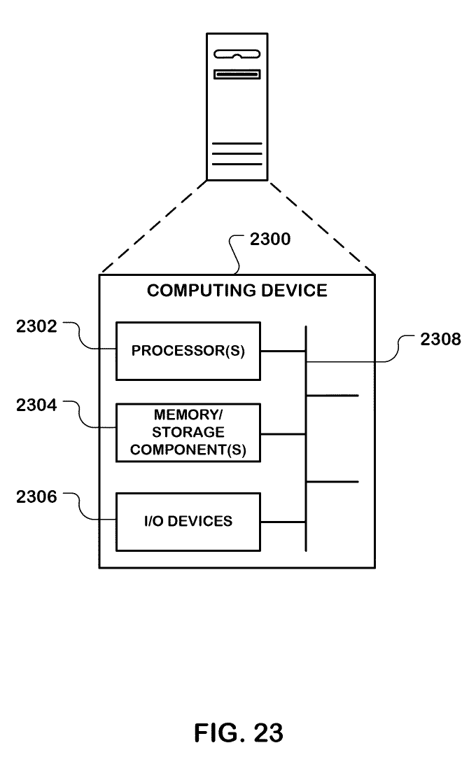

FIG. 23 illustrates one embodiment of a computing device 2300 which can be used in one embodiment of a system to implement the various described embodiments for the computer implemented dashboard and the computer implemented control method, among others, as set forth in this specification. The computing device 2300 may be employed to implement one or more of the computing devices discussed hereinabove. For the sake of clarity, the computing device 2300 is illustrated and described here in the context of a single computing device. It is to be appreciated and understood, however, that any number of suitably configured computing devices can be used to implement any of the described embodiments. For example, in at least some implementations, multiple communicatively linked computing devices are used. One or more of these devices can be communicatively linked in any suitable way such as via one or more networks. One or more networks can include, without limitation: the Internet, one or more local area networks (LANs), one or more wide area networks (WANs) or any combination thereof.

In this example, the computing device 2300 comprises one or more processor circuits or processing units 2302, one or more memory circuits and/or storage circuit component(s) 2304 and one or more input/output (I/O) circuit devices 2306. Additionally, the computing device 2300 comprises a bus 2308 that allows the various circuit components and devices to communicate with one another. The bus 2308 represents one or more of any of several types of bus structures, including a memory bus or memory controller, a peripheral bus, an accelerated graphics port, and a processor or local bus using any of a variety of bus architectures. The bus 2308 may comprise wired and/or wireless buses.

The processing unit 2302 may be responsible for executing various software programs such as system programs, applications programs, and/or modules to provide computing and processing operations for the computing device 2300. The processing unit 2302 may be responsible for performing various voice and data communications operations for the computing device 2300 such as transmitting and receiving voice and data information over one or more wired or wireless communications channels. Although the processing unit 2302 of the computing device 2300 includes single processor architecture as shown, it may be appreciated that the computing device 2000 may use any suitable processor architecture and/or any suitable number of processors in accordance with the described embodiments. In one embodiment, the processing unit 2302 may be implemented using a single integrated processor.

The processing unit 2302 may be implemented as a host central processing unit (CPU) using any suitable processor circuit or logic device (circuit), such as a as a general purpose processor. The processing unit 2302 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 2302 may be coupled to the memory and/or storage component(s) 2304 through the bus 2308. The memory bus 2308 may comprise any suitable interface and/or bus architecture for allowing the processing unit 2302 to access the memory and/or storage component(s) 2304. Although the memory and/or storage component(s) 2304 may be shown as being separate from the processing unit 2302 for purposes of illustration, it is worthy to note that in various embodiments some portion or the entire memory and/or storage component(s) 2304 may be included on the same integrated circuit as the processing unit 2302. Alternatively, some portion or the entire memory and/or storage component(s) 2304 may be disposed on an integrated circuit or other medium (e.g., hard disk drive) external to the integrated circuit of the processing unit 2302. In various embodiments, the computing device 2300 may comprise an expansion slot to support a multimedia and/or memory card, for example.

The memory and/or storage component(s) 2304 represent one or more computer-readable media. The memory and/or storage component(s) 2304 may be implemented using any computer-readable media capable of storing data such as volatile or non-volatile memory, removable or non-removable memory, erasable or non-erasable memory, writeable or re-writeable memory, and so forth. The memory and/or storage component(s) 2304 may comprise volatile media (e.g., random access memory (RAM)) and/or nonvolatile media (e.g., read only memory (ROM), Flash memory, optical disks, magnetic disks and the like). The memory and/or storage component(s) 2304 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 2306 allow a user to enter commands and information to the computing device 2300, and also allow information to be presented to the user and/or other components or devices. Examples of input devices include a keyboard, a cursor control device (e.g., a mouse), a microphone, a scanner and the like. Examples of output devices include a display device (e.g., a monitor or projector, speakers, a printer, a network card, etc.). The computing device 2300 may comprise an alphanumeric keypad coupled to the processing unit 2302. The keypad may comprise, for example, a QWERTY key layout and an integrated number dial pad. The computing device 2300 may comprise a display coupled to the processing unit 2302. The display may comprise any suitable visual interface for displaying content to a user of the computing device 2300. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 2302 may be arranged to provide processing or computing resources to the computing device 2300. For example, the processing unit 2302 may be responsible for executing various software programs including system programs such as operating system (OS) and application programs. System programs generally may assist in the running of the computing device 2300 and may be directly responsible for controlling, integrating, and managing the individual hardware components of the computer system. The OS may be implemented, for example, as a Microsoft® Windows OS, Symbian OSTM, Embedix OS, Linux OS, Binary Run-time Environment for Wireless (BREW) OS, JavaOS, Android OS, Apple OS or other suitable OS in accordance with the described embodiments. The computing device 2300 may comprise other system programs such as device drivers, programming tools, utility programs, software libraries, application programming interfaces (APIs), and so forth.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

It also is to be appreciated that the described embodiments illustrate example implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

It is worthy to note that any reference to “one embodiment” or “an embodiment” means that a particular feature, structure, or characteristic described in connection with the embodiment is included in at least one embodiment. The appearances of the phrase “in one embodiment” or “in one aspect” in the specification are not necessarily all referring to the same embodiment.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patent applications cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Certain ranges have been presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

As will be apparent to those of skill in the art upon reading this disclosure, each of the individual aspects described and illustrated herein has discrete components and features which may be readily separated from or combined with the features of any of the other several aspects without departing from the scope of the present invention. Any recited method can be carried out in the order of events recited or in any other order which is logically possible.

The foregoing description is provided as illustration and clarification purposes only and is not intended to limit the scope of the appended claims to the precise forms described. Other variations and embodiments are possible in light of the above teaching, and it is thus intended that the scope of the appended claims not be limited by the detailed description provided hereinabove. Although the foregoing description may be somewhat detailed in certain aspects by way of illustration and example for purposes of clarity of understanding, it is readily apparent to those of ordinary skill in the art in light of the present teachings that certain changes and modifications may be made thereto without departing from the scope of the appended claims. Furthermore, it is to be understood that the appended claims are not limited to the particular embodiments or aspects described hereinabove, and as such may vary. It is also to be understood that the terminology used herein is for the purpose of describing particular embodiments and aspects only, and is not intended to limit the scope of the appended claims.

1. An apparatus, comprising:
a housing comprising at least one inlet plug suitable for connection to an alternating current (AC) power outlet and at least one outlet receptacle suitable receiving an AC plug connected to a load device;
an AC measurement module coupled to the inlet plug and the outlet receptacle to measure AC voltage and AC current usage of the load device connected to the outlet receptacle; and
a communication module operative to transmit AC power values calculated based on the measured AC voltage and AC current in accordance with the IEEE 802.11 wireless networking standard (Wi-Fi) to a wireless network access point.

2. The apparatus of claim 1, comprising a control module coupled to the communication module, wherein the control module is operative to control a state of the at least one outlet receptacle based on digital commands received by the communication module from the wireless network access point.

3. The apparatus of claim 2, wherein the control module is operative to turn the at least one outlet receptacle either in an ON state or an OFF state based on the digital commands received by the communication module.

4. The apparatus of claim 3, comprising a single an inlet plug suitable for connection to an AC power outlet and a plurality of outlet receptacles suitable receiving a plurality of AC plugs connected to a plurality of load devices.

5. The apparatus of claim 4, wherein the control module comprises a multi-socket manager system to control the plurality of load devices plugged into the plurality of outlet receptacles.

6. The apparatus of claim 1, comprising:
a processor coupled to the AC measurement module; and
a memory coupled to the processor;
wherein the processor is operative to receive digitized AC voltage and AC current measurement samples from the AC measurement module, calculate AC power values based on the received AC voltage and AC current measurement samples, and store the digitized AC power values in the memory; and
wherein the processor is operative to initiate communication with the communication module to transmit the digitized AC power values stored in the memory to the wireless network access point.

7. The apparatus of claim 6, wherein the AC measurement module comprises:
an AC voltage sense system coupled to the inlet plug;
an AC current sense system coupled to the inlet plug; and
an analog-to-digital (A/D) converter coupled to the AC voltage sense system and the AC current sense system and coupled to the processor, wherein the A/D converter is operative to digitize the AC voltage and AC current measurements provided by the corresponding AC voltage sense system AC current sense system at a predetermined sampling rate and to provide the digitized AC voltage and AC current samples to the processor, wherein the processor is operative to calculate power based on the AC voltage and AC current samples.

8. The apparatus of claim 7, wherein the AC current sense system comprises:
a first current sensor coil element to produce a first set of differential signals that are proportional to the AC current in a first leg of the inlet plug and are suitable for input to the A/D converter; and
a second current sensor coil element to produce a second set of differential signals that are proportional to the AC current in a second leg of the inlet plug and are suitable for input to the A/D converter.

9. The apparatus of claim 8, wherein the AC voltage sense system comprises:
a first set of resistors to divide the voltage between the first leg of the inlet plug and neutral to produce a first differential voltage signal suitable for input to the A/D converter; and
a second set of resistors to divide the voltage between the second leg of the inlet plug and neutral to produce a second differential voltage suitable for input to the A/D converter.

10. The apparatus of claim 1, wherein the communication module is operative to transmit wireless signals to and receive wireless signals from the wireless network access point in accordance with the IEEE 802.11 wireless networking standard (Wi-Fi).

11. A wireless network for monitoring alternating current (AC) power usage of a device connected to an AC power meter wireless module, the wireless network comprising:
at least one AC power meter wireless module configured to receive at least one device operative on AC power and further configured to plug into an AC outlet, the at least one AC power meter wireless module comprising:
a housing comprising at least one inlet plug suitable for connection to an alternating current (AC) power outlet and at least one outlet receptacle suitable receiving an AC plug connected to a load device;
an AC measurement module coupled to the inlet plug and the outlet receptacle to measure AC voltage and AC current usage of the load device connected to the outlet receptacle; and
a communication module operative to transmit AC power values calculated based on the measured AC voltage and AC current in accordance with the IEEE 802.11 wireless networking standard (Wi-Fi) to a wireless network access point.

12. The wireless network of claim 11, wherein the at least one AC power meter wireless module comprises a control module coupled to the communication module, wherein the control module is operative to control a state of the at least one outlet receptacle based on digital commands received by the communication module.

13. The wireless network of claim 12, wherein the control module is operative to turn the at least one outlet receptacle either in an ON state or an OFF state based on the digital commands received by the communication module.

14. The wireless network of claim 13, wherein the at least one AC power meter wireless module comprises a single an inlet plug suitable for connection to an AC power outlet and a plurality of outlet receptacles suitable receiving a plurality of AC plugs connected to a plurality of load devices.

15. The wireless network of claim 14, wherein the control module comprises a multi-socket manager system to control the plurality of load devices plugged into the plurality of outlet receptacles.

16. The wireless network of claim 11, wherein the AC measurement module comprises:
a processor coupled to the AC measurement module; and
a memory coupled to the processor;
wherein the processor is operative to receive digitized AC voltage and AC current measurement samples from the AC measurement module, calculate AC power values based on the received AC voltage and AC current measurement samples, and store the digitized AC power values in the memory; and
wherein the processor is operative to initiate communication with the communication module to transmit the digitized AC power values stored in the memory to the wireless network access point.

17. The wireless network of claim 16, wherein the AC measurement module comprises:
an AC voltage sense system coupled to the inlet plug;
an AC current sense system coupled to the inlet plug; and
an analog-to-digital (A/D) converter coupled to the AC voltage sense system and the AC current sense system and coupled to the processor, wherein the A/D converter is operative to digitize the AC voltage and AC current measurements provided by the corresponding AC voltage sense system AC current sense system at a predetermined sampling rate and to provide the digitized AC voltage and AC current samples to the processor, wherein the processor is operative to calculate power based on the AC voltage and AC current samples.

18. The wireless network of claim 17, wherein the AC current sense system comprises:
a first current sensor coil element to produce a first set of differential signals that are proportional to the AC current in a first leg of the inlet plug and are suitable for input to the A/D converter; and
a second current sensor coil element to produce a second set of differential signals that are proportional to the AC current in a second leg of the inlet plug and are suitable for input to the A/D converter.

19. The wireless network of claim 18, wherein the AC voltage sense system comprises:
a first set of resistors to divide the voltage between the first leg of the inlet plug and neutral to produce a first differential voltage signal suitable for input to the A/D converter; and
a second set of resistors to divide the voltage between the second leg of the inlet plug and neutral to produce a second differential voltage suitable for input to the A/D converter.

20. The wireless network of claim 11, wherein the communication module is operative to transmit wireless signals to and receive wireless signal from the wireless network access point in accordance with the IEEE 802.11 wireless networking standard (Wi-Fi).

21. A method, comprising:
receiving from at least one inlet plug suitable for connection to an alternating current (AC) power outlet and at least one outlet receptacle suitable receiving an AC plug connected to a load device an AC current signal and an AC voltage signal;
measuring by an AC measurement module coupled to the inlet plug and the outlet receptacle to the AC voltage and the AC current usage of the load device connected to the outlet receptacle; and
transmitting AC power usage based on the AC current and AC voltage measured by the by AC measurement module in accordance with the IEEE 802.11 wireless networking standard (Wi-Fi) to a wireless network access point.

22. The method of claim 21, comprising controlling, by a control module coupled to the communication module, a state of the at least one outlet receptacle based on digital commands received by the communication module.

23. The method of claim 22, turning, by the control module, the at least one outlet receptacle either in an ON state or an OFF state based on the digital commands received by the communication module.

24. The method of claim 23, controlling, by a multi-socket manager system, a plurality of load devices plugged into a plurality of outlet receptacles.

25. The method of claim 21, comprising:
receiving, by a processor coupled to the AC measurement module, digitized AC measurement samples from the AC measurement module;
calculating AC power values based on the digitized AC measurement samples;
storing, by the processor, the AC power values in a memory coupled to the processor;
initiating, by the processor, communication with the communication module; and
transmitting, by the communication module, the AC power values stored in the memory to the wireless network access point.
